(19) United States
(12) Patent Application Publication
(10) Pub. No.: US 2018/0295800 A1
(43) Pub. Date: Oct. 18, 2018

(54) VERTICALLY ORIENTED MODULAR AEROHYDROPONIC SYSTEMS AND METHODS OF PLANTING AND HORTICULTURE

(71) Applicant: PHIDRO LLC, New York, NY (US)

(72) Inventor: John Thomas Kiernan, Basking Ridge, NJ (US)

(73) Assignee: PHIDRO LLC, New York, NY (US)

(21) Appl. No.: 15/490,669

(22) Filed: Apr. 18, 2017

(51) Int. Cl. A01G 31/06; A01D 45/00

(52) U.S. Cl. CPC A01G 31/06; A01D 45/00

(57) ABSTRACT

Vertically oriented modular systems and methods for horticulture using stackable, removable containers dimensioned according to the Fibonacci Sequence and configured to hold plants with or without sub-containers with roots wholly or partially submerged in aqueous nutrient solution for aerohydroponic growth with intake and outtake apertures and at least one conduit to deliver, air, and/or aqueous nutrient solution in fluid communication with other stacked containers, and adjustable baffling to control nutrient solution delivery. The containers are releasably divisible across the face of the container to promote removal, harvest and transplantation without disrupting or damaging plant roots. The containers can also be configured with sensors paired or connected to a computing system to monitor, measure, and store data related to monitoring plant growth. Mounting systems with container center of gravity below the mounting point for stability and automated track based systems for planting, monitoring, and lighting, and harvesting can also be used.

### FIELD OF THE INVENTION

The present invention relates to horticultural systems and methods. Specifically, the present invention relates to vertically oriented modular aerohydroponic systems and methods for horticulture.

### BACKGROUND

Various horticultural methods and systems are known that have been designed to increase plant yield, efficiently use space, and reduce reliance on manual processes to grow, maintain, and harvest plants. In order to more efficiently use growing area and increase yield density, a number of these methods and systems are orientated vertically. Examples of these systems include: Wall Planting System, U.S. Pat. Pub. No, 20110192084, Device for Growing Plants on a Vertical Substrate, U.S. Pat. Pub. No. 20110215937, and Vertical. Planter, U.S. Pat. Pub. No. 20110258925.

These systems may further employ methods that do not rely on traditional soil based methods for nutrient delivery, including hydroponic, aeroponic, and aerohydroponic methods. These methods and offer superior control and production to traditional soil-based methods and reduce reliance on manual processes to grow, maintain, and harvest plants. Such systems and methods also can include systems for lighting (photoradiation), growth monitoring, planting, pruning and harvesting.

Hydroponic systems and methods involve growing plants without soil, using mineral nutrient solutions in a water solvent. Plants may be grown hydroponically with only their roots exposed to a mineral solution or the roots may he supported by an inert medium, such as perlite or gravel. Examples of hydroponic systems include: Vertical Plant Supporting system, U.S. Pat. Pub. No. 20090223126, Plant Growing Assembly, U.S. Pat. Pub. No. 20100024292, Vertical Planting Apparatus, U.S. Pat. Pub. No. 20120066972, and Modular Plant Growing Device, U.S. Pat. Pub. No. 20100146855.

In aeroponic systems, plant roots are continuously or discontinuously maintained in an environment where they are saturated with fine drops (a mist or aerosol) of nutrient solution. The aeroponic method does not require substrate and entails growing plants with their roots suspended in a deep air or growth chamber with the roots periodically wetted with a fine mist of atomized nutrients. Excellent aeration is a principal advantage of aeroponic systems. Aeroponic techniques have proven to be commercially successful for propagation, seed germination, tomato production, leaf crops, and micro-greens. An example of an aeroponic system includes: Modular Aeroponic/Hydroponic container Mountable to a Surface, U.S. Pat. Pub. No. 20060156624.

Advanced forms of aeroponic and hydroponic nutrition systems offer superior control and delivery of nutrients as compared to traditional soil based methods. Additionally, in aeroponic, hydroponic, and aerohyrdroponic systems, artificial light can be used to augment or replace the sun and computers can be used to automate processes for monitoring, maintaining and harvesting plants, as well as reducing required manual intervention.

Aerohydroponic systems combine aeroponic and hydroponic methods. Aerohydroponic systems immerse the root system of a plant in an aqueous nutrient solution that is continuously aerated to improve nutrient and water absorption and facilitate increased gas exchange. FIGS. 19 A and 19B depict examples of aerohydroponic growth with the roots of plants 1901-1908 partially or wholly submerged in an aqueous nutrient solution 1910. FIGS. 19A and 19B depict aerohydroponic function where the gases necessary for the roots of plants 1901, 1902, 1903, 1904, 1905, 1906, 1907, and 1908 to grow submerged continuously are introduced via a gaseous diffuser 1920 to the aqueous nutrient solution 1910. Examples of aerohydroponic systems include: Aerohydroponic Circulation, U.S. Pat. Pub. No. 20030213170, Spraying and Level Control for Aero-Hydroponic System, U.S. Pat. No. 5,557,884, Water, Light and Airflow Control System and Configuration for a Plant Air Purifier, U.S. Pat. No. 8,894,741, Hydroponic Plant Container with Highly Oxygenated Nutrient Solution Using Continuous Air Injection and Continuous Coriolis Effect Mixing, U.S. Pat. No. 8,667,734, Domestic Plant Factory Capable of Air Purification, U.S. Pat. Pub. No. 20140190078, Water, Light and Airflow Control System and Configuration for a Plant Air Purifier, U.S. Pat. Pub. No. 20110154985, Mechanism for Aeration and Hydroponic Growth of Plant Applications, U.S. Pat. Pub. No. 20130081327.

Orienting horticultural systems in the vertical direction has resulted in increased growth density output and efficiencies in space utilization. Vertical hydroponic or aeroponic structures are known in the art. Known “vertical growth” systems have focused on structures in which plant growth adheres to a vertical structure (as opposed to the structure supporting or creating the growth). Vertical structures fall into two categories: “facades” and “vertical growth systems.” “Facades” are composed of climbing plants, either growing directly on a wall or a support framework mounted to the wall. A key distinction of this type of system is that the plants are rooted in the ground or other base. A “vertical growth system” is a modular panel or container system that uses containers filled with a growth medium that supports a plant and houses its root system. Vertical growth systems come in several varieties, including mat media, loose media, and structural varieties.

Mat media systems use fiber or cloth mats, but the supports used for these systems are thin (even in layers) and cannot support robust plant root systems. Examples of mat media systems include: Vegetation Wall, U.S. Pat. Pub. No. 20110225883, and Aquaponic Vertical Garden with Integrated Air Channel for Plant-Based Air Filtration, U.S. Pat. Pub. No. 20130160363.

Loose media type systems can be described as “soil-on-a-shelf” or “soil-in-a-bag” systems, where soil (or other nutrient providing media) is placed in a container, which is mounted to a wall. Examples of loose media type systems include: System for Plant Cultivation in Containers in a Vertical or Sloped Arrangement, U.S. Pat. Pub. No. 20150121756, System for Plant Cultivation in Containers in a Vertical or Sloped Arrangement, U.S. Pat. No. 9,258,948, and Wall-Surface Flower Bed Structure and Method for Forming Wall-Surface Flower Bed, U.S. Pat. Pub. No. 20150230412.

Structural type living walls can be described as growth medium blocks that are assembled to form a wall. These growth medium blocks may employ a variety of irrigation methods. Examples of systems with structural type living walls include: Green. Wall Planting Module, Support Structure and Irrigation control system U.S. Pat. No. 7,788,848, Green Wall Planting module, Support Structure and Irrigation Control System, U.S. Pat. Pub. No. 20110088319, Building Envelope Member with Internal Water Reservoir, U.S. Pat. Pub. No. 20130104994, and Water Catchment Building Block, U.S. Pat. No. 8448403.

Vertical growth systems also employ advanced, irrigation techniques including hydroponic and aeroponic irrigation systems that may include modular interlocking containers to promote fluid communication when using those irrigation techniques.

There are several challenges associated with vertical growth systems including: inhibited photosynthetic function (plants need to grow vertically), limiting potential growth (by placing them on top of one another), efficiently utilizing photo radiation, achieving high levels of growth density, promoting the development of robust root systems, containment and fertigation of growth substrate, and system stability. Advanced configurations employing interlocking modules have emerged that incorporate elements of modularity and “stackability.” However, they typically do not permit substantial root growth, easy removal of mature growth, or include automated monitoring and harvesting.

Loose media interlocking module systems require constant maintenance, and are typically difficult to irrigate and fertigate. Examples of loose media based systems with interlocking modules include: Flowerpot with Water Distribution Device, U.S. Pat. Pub. No. 20150096229, Power-Saving Flowerpots Capable of Serial Connecting with Other Flowerpots, U.S. Pat. Pub. No. 20120186148, Interlocking Plant Propagation and Display Tray and Method of Use and Assembly, U.S. Pat. No. 9,004,298, Vertical garden Systems and Methods U.S. Pat. Pub. No. 20130104456, Tower Planter Growth Arrangement and Method, U.S. Pat. Pub. No. 20140208647, Planting Wall Container Structure, U.S. Pat. Pub. No. 20150082698, Connected Containers, U.S. Pat. No. 5,095,653, Multi-Tier Garden Planter with Sectional Tubs, U.S. Pat. No. 5,428,922, Modular Planting and Cultivating Container and System and Revegetation Method Using Such Containers, U.S. Pat. Pub. No. 20120240463, Flowerpot, U.S. Pat. Pub. No. 20100325953, Self-Irrigating, Multi-Tier Vertical Planter, U.S. Pat. No. 4,419,843, Stackable Planting Containers with Capillary Watering, U.S. Pat. No. 6,993,869, Planting Container and Planting Tower U.S. Pat. No. 8,776,433, Stackable Planting containers with Capillary Watering, U.S. Pat. Pub. No. 20050183334, and Hanging Stacked Plant Holders and Watering Systems, U.S. Pat. No. 8,418,403,

Hydroponic interlocking systems are typically more expensive to purchase and maintain than loose media type systems because of the increased complexity of the required plumbing and are more expensive to maintain due to increased maintenance requirements and probability of malfunction, but offer the efficiencies and advantages of hydroponic growth. Examples of hydroponic interlocking systems include: Plant Pot Holding Device, U.S. Pat. No. 8,250,804, Plant Cultivation Container, U.S. Pat. No. 8,959,834, Hanging Flowerpot Structure, U.S. Pat. Pub. No. 20130014438, Fabricated cultivation box and fabricated landscape architecture system U.S. Pat. Pub. No. 8,646,205, Hydroponic Modular Planting System U.S. Pat. Pub. No. 20130118074, Hydroponic Growing System U.S. Pat. No. 9,101,099, Plant Cultivation Container, U.S. Pat. Pub. No. 20120272573, Light-weight Modular Adjustable Vertical Hydroponic Growing System and Method, U.S. Pat. Pub. No. 20150223418, Vertical Planter Apparatus and Method, U.S. Pat. No. 5,555,676, Modular Self-Sustaining Planter System, U.S. Pat. No. 9,043,962, and Hydroponic Growth Systems and Methods, U.S. Pat. No. 5,502,923.

Aeroponic interlocking module systems are the most expensive to purchase and maintain, but offer the efficiencies of aeroponic growth. Examples of aeroponic interlocking module systems include: Modular Plant Growing Apparatus, U.S. Pat. No. 7,080,482, In-Room Hydroponic Air Cleansing Unit, U.S. Pat. Pub. No. 20140283450, Growing System for Hydroponics and/or Aeroponics, U.S. Pat. Pub. No 20140101999, and Cultivation System for Medicinal Vegetation, U.S. Pat. Pub. No. 20120167460.

Aerohydroponic systems offer advantages that aeroponic and hydroponic systems do not. While aeroponic and hydroponic systems both deliver nutrients directly to the plant's roots, the aerohydroponic method maximizes the availability of those nutrients as well as oxygen, promoting enhanced plant growth. Hydroponic, aeroponic and aerohydroponic systems present difficulties with regard to plant maintenance, monitoring, pruning, and harvesting, particularly when constructed as vertical, modular systems, to take advantage of the efficiencies from growing plants in the vertical direction. Similarly, these types of systems also present difficulties in removing mature plants that are partially submerged in nutrient solution without damaging the plants or disrupting nutrient delivery to other plants, limiting the potential for transplantation.

Vertical horticultural systems use these various vertical configurations and methods to produce crops in dense systems, and typically involve the ‘stacking’ of tracks of crops, but they do not typically permit substantial root growth, easy removal of mature growth, or facilitate automation. Examples of vertical farming (vertical horticulture) systems include: Vertical Agricultural Structure, U.S. Pat. Pub. No. 20130326950, Construction of Vertical Farm, WO2013063739, Indoor farming Device and Method, U.S. Pat. No. 9,357,718, Combined Vertical Farm, Biofuel, Biomass, and Electric Power Generation Process and Facility, U.S. Pat. Pub. No. 20110131876, and Permeable Three Dimensional Multi-Layer Farming, U.S. Pat. Pub. No. 20140325909.

Other types of horticultural systems that seek to increase the density of crops, such as circular and rotational module systems, couple the efficiencies of hydroponic and/or aeroponic growth with the space saving and lighting efficiencies of proximal distancing. But the space efficiency of a circular versus square system of the same size will typically be in favor of the square (due to the greater interior surface area). Additionally, the mechanical complications of this type of system increase purchase and maintenance costs. Moreover, circular and rotational modular systems do not typically permit substantial root growth, easy removal of mature growth, or include automated monitoring and harvesting functionality. Examples of circular and rotational modular systems include: Automatic Agricultural Cultivating Equipment with a Loading Unit Rotatable About a Vertical Axis, U.S. Pat. Pub. No. 20140196363, and Multipurpose Growing System, U.S. Pat. Pub. No. 20060201058.

In addition to increasing the efficiency of space utilization, horticultural systems use systems of fertigation, lighting (photoradiation), growth monitoring, planting, pruning and harvesting to automate and optimize production.

Fertigation is the injection of fertilizers, soil amendments, and other water-soluble products into an irrigation system. An example of a fertigation system includes: Integrated SAP Flow Monitoring, Data Logging, Automatic Irrigation Control Scheduling System, U.S. Pat. Pub. No. 20050121536.

Lighting systems used in indoor horticultural systems typically control artificial light source (generally an electric light) designed to stimulate plant growth by emitting an electromagnetic spectrum appropriate for photosynthesis. A range of bulb types can be used as grow lights, such as incandescent, fluorescent lights, high-intensity discharge lamps (HID), and light-emitting diodes (LED). An example of a lighting system for use in indoor horticultural systems includes: Devices and Methods for Growing Plants U.S. Pat. Pub. No. 20080222949.

Growth monitoring is a growth management concept based on observing, measuring and responding to variability in crops, aimed at optimizing system management, and creating a database of crop related information. Examples of growth monitoring systems include: Irrigation system including a graphical user interface U.S. Pat. Pub. No. 20140039696, Real-time Plant Health Monitoring System, U.S. Pat. Pub. No. 20070208512, and Harvesting Device, Grow Space, Grow System and Method, U.S. Pat. Pub. No. 20130340329.

Planting, pruning, and harvesting are all processes that need to be done to maintain plants during growth and to and gather plants for harvesting upon maturity. An example of a system that uses mechanical or robotic execution of those processes includes: Semi-Automated Crop Production System, U.S. Pat. No. 9,101,096.

What is needed is an automated system method for aerohydroponic growing that uses a modular, vertical approach to take advantage of the efficiencies of increased growth density and advanced nutrient delivery of aerohydroponics and vertical systems, hut overcomes problems of maintenance, monitoring, and harvesting that have prevented aerohydroponic systems from being able to be implemented in a vertical, modular manner. The invention described in detail below achieves these objectives and overcomes these problems.

### SUMMARY OF THE INVENTION

In one aspect, a system for aerohydroponic horticulture is provided comprising a plurality of containers, the containers each having a face portion and at least one intake aperture and outtake aperture configured to hold an aqueous nutrient solution and plant with roots partially or wholly submerged in the aqueous nutrient solution for aerohydroponic growth, the containers dimensioned according to the Fibonacci Sequence and having at least one conduit connected to the containers at the intake aperture, and the outtake aperture, the at least one conduit comprising an opening to deliver air, and/or aqueous nutrient solution to the containers, the containers having watertight seal and releasably divisible across the face portion into first and second container portions, the plurality of containers stacked vertically and in fluid communication through the at least one conduit; an air delivery system connected to the plurality of containers through the at least one conduit; and an aqueous nutrient solution delivery system connected to the plurality of containers through the at least one conduit.

In one embodiment, the containers are trapezoidal, mirrored-trapezoidal, conical, circular, or inverted circular in shape.

In another embodiment, the containers further comprise one or more receptacles for plants, the receptacles comprising a soilless growth medium. In another embodiment, the containers further comprise a rack and pinion mechanism for revolving the one or more receptacles of the containers.

In another embodiment, the containers further comprise baffling for forming an aqueous nutrient solution reservoir in the containers, the baffling having an adjustable mechanism that regulates the level of the aqueous nutrient solution in the containers.

In another embodiment, the adjustable mechanism for the baffling comprises a plate with orifices that fits against the baffling and regulative orifices such that the plate orifices and the regulative orifices can be aligned to increase flow or misaligned to decrease flow of nutrient solution in the containers and the air delivery system comprises an inlet and outlet, whereby the inlet draws from ambient environmental air and the outlet is connected to the one or more conduits and provides air to the roots partially or wholly submerged in the aqueous nutrient solution.

In another embodiment, the system further comprises a frame to house the containers that can be mounted to a wall or other vertical support with fasteners at a mounting point, wherein the containers are removable from the frame and have a center of gravity below the mounting point and internal stanchions provide support to a stack of aerohydroponic containers and permit the use of internal plumbing systems for the conduits.

In another embodiment, the system further comprises a computing system, wherein the containers are further configured to comprise sensors that can be connected or paired to or with the computing system to measure and store data, including aqueous nutrient solution oxygen availability, aqueous nutrient solution nutrient levels (electrical conductivity), aqueous nutrient solution pH level, temperature, barometric pressure, light levels, humidity, carbon dioxide levels, aqueous nutrient solution cistern liquid level and concentrated aqueous nutrient solution cistern liquid level, wherein the computing system can communicate the stored data to a computing device and generate alerts and trigger automated system functionality.

In another embodiment, the system further comprises an aqueous nutrient solution delivery system comprising a pump or solenoid and one or more conduits that move nutrient solution from the aqueous nutrient solution cistern to a first, uppermost container and additional containers, wherein the first container and additional containers are in fluid communication.

In another embodiment, a photoradiation unit comprising at least one vertically or transversely mounted photoradiation device is used.

In another embodiment, the aqueous nutrient delivery system further comprises at least one dehumidifier unit that adds water to the aqueous nutrient solution cistern.

In another embodiment, the system further comprises a track system with movable boom capable of moving in three dimensions along an x, y, and z, axis, further comprising a data acquisition and pruning and harvesting system, wherein the data acquisition system comprises a camera for obtaining pictures, wherein the pruning and harvesting system comprise a compressed air mechanism, saw, or shears.

In a second aspect, a method for aerohydroponic growing is provided, comprising: depositing at least one or more seeds inside soilless growth medium inside one or more receptacles; placing the one or more receptacles inside an individual container, the container having a face portion and at least one intake aperture and outtake aperture, the container dimensioned according to the Fibonacci Sequence and having at least one conduit connected to the container at an intake aperture, and an outtake aperture, and one or more sensors connected to a computing system that measures data including: aqueous nutrient solution oxygen availability, aqueous nutrient solution nutrient levels (electrical conductivity), aqueous nutrient solution level, temperature, barometric pressure, light levels, humidity, carbon dioxide levels, aqueous nutrient solution cistern liquid level and concentrated aqueous nutrient solution cistern liquid level and stores the data on the computing system, wherein the computing system monitors the sensors, communicates the stored data to a computing device and generates system status and sensor level alerts; stacking a plurality of the individual containers vertically so that the stacked containers are in fluid communication through the intake aperture and the outtake aperture; and providing an aqueous nutrient solution to the containers and so that plants will grow in the receptacles with roots partially or wholly submerged in the aqueous nutrient solution for aerohydroponic growth; providing oxygen to the containers through an air delivery system comprising an air pump and gaseous diffusion apparatus in fluid communication with the intake aperture and the outtake aperture.

In another embodiment, the method further comprises: connecting or pairing the one or more sensors to a computing system; and measuring and storing in the computer system data of aqueous nutrient solution oxygen availability, aqueous nutrient solution nutrient levels, aqueous nutrient solution pH level (electrical conductivity), temperature, barometric pressure, light levels, humidity, carbon dioxide levels, aqueous nutrient solution cistern liquid level and concentrated aqueous nutrient solution cistern liquid level.

In another embodiment, the method further comprises the computing system sending data and alerts from the computing system to a user computer or device when aqueous nutrient solution oxygen availability, aqueous nutrient solution nutrient levels aqueous nutrient solution pH level (electrical conductivity), temperature, barometric pressure, light levels, humidity, carbon dioxide levels, aqueous nutrient solution cistern liquid level and concentrated aqueous nutrient solution cistern liquid level falls outside of predetermined ranges.

In another embodiment, the method further comprises removing and opening the containers to prune and harvest and permit transplantation of plants growing in the containers without disrupting or damaging roots of plants.

In third aspect, a container for growing plants aerohydroponically is provided, comprising a face portion, a rear portion, and side portion, and at least one intake aperture and outtake aperture, for aerohydroponic growth, dimensioned according to the Fibonacci Sequence and configured to hold an aqueous nutrient solution and plant with roots partially or wholly submerged in the aqueous nutrient solution for aerohydroponic growth and to connect to at least one conduit connected to the containers at the intake aperture, and the outtake aperture, the at least one conduit comprising an opening to deliver air, and/or aqueous nutrient solution to the containers, the containers releasably divisible across the face into first and second container portions.

In one embodiment, the container further comprises one or more sensors that can be connected to a computing system to measure and store data of aqueous nutrient solution oxygen availability, aqueous nutrient solution nutrient levels, aqueous nutrient solution pH level (electrical conductivity), temperature, barometric pressure, light levels, humidity, carbon dioxide levels, aqueous nutrient solution cistern liquid level and concentrated aqueous nutrient solution cistern liquid levels.

In other embodiments, the container further comprises one or more receptacles for housing plants, the receptacles comprising a soilless growth medium; and a rack and pinion mechanism for revolving the receptacles and an adjustable mechanism to control the delivery of nutrient solution to the containers.

In another embodiment, the adjustable mechanism comprises a plate with orifices that fits against the baffling and regulative orifices such that the plate orifices and the regulative orifices can be aligned to increase flow or misaligned to decrease flow of nutrient solution in the container,

### BRIEF DESCRIPTION OF THE DRAWINGS

For a more complete understanding of the invention, reference is made to the following description and accompanying drawings, in which:

FIG. 1A depicts a front view of a complete aerohydroponic system with vertical, stackable containers according to the invention.

FIG. 1B depicts a side view of a complete vertical, stackable aerohydroponic system according to the invention.

FIG. 1C depicts a perspective view of a complete vertical, stackable aerohydroponic system according to the invention.

FIG. 2A depicts a front view of an example of the stackable modular aerohydroponic containers according to the invention.

FIG. 2B depicts a side view of an example of the stackable modular aerohydroponic containers according to the invention.

FIG. 2C depicts a perspective view of an example of the stackable modular aerohydroponic containers according to the invention.

FIG. 3A depicts a side view of an example of a container dimensioned in accordance with the Fibonacci Sequence that can be used in accordance with the invention.

FIG. 3B depicts a side view of an example of a container dimensioned in accordance with the Fibonacci Sequence that can be used in accordance with the invention.

FIG. 4A depicts examples of perspective and side views of a trapezoidal shaped container that can be used with the invention that is dimensioned in accordance with the Fibonacci Sequence.

FIG. 4B depicts examples of side and perspective views of a mirrored trapezoidal shaped container that can be used with the invention that is dimensioned in accordance with the Fibonacci Sequence.

FIG. 4C depicts examples of side and perspective views of a conical shaped container dimensioned in accordance with the Fibonacci Sequence that can be used in accordance with the invention.

FIG. 4D depicts examples of side and perspective views of a circular shaped container dimensioned in accordance with the Fibonacci Sequence that can be used with the invention.

FIG. 4E depicts examples of side and perspective views of an inverted circular shaped container dimensioned in accordance with the Fibonacci Sequence that can be used in accordance with the invention.

FIG. 4F depicts an example of a perspective view of how a trapezoidal Shaped container dimensioned in accordance with the Fibonacci Sequence can be stacked in accordance with the invention.

FIG. 4G depicts an example of how a mirrored trapezoidal shaped container dimensioned in accordance with the Fibonacci Sequence can be stacked in accordance with the invention.

FIG. 4H depicts an example of how a conical shaped container dimensioned in accordance with the Fibonacci Sequence can be stacked in accordance with the invention.

FIG. 4I depicts an example of how a circular shaped container dimensioned in accordance with the Fibonacci Sequence can be stacked in accordance with the invention.

FIG. 4J depicts an example of how an inverted circular shaped container dimensioned in accordance with the Fibonacci Sequence can be stacked in accordance with the invention.

FIG. 5A depicts a front view example of a stackable divisible container dimensioned in in accordance with the Fibonacci Sequence that permits the complete removal of mature growth used in accordance with the invention in accordance with the invention.

FIG. 5B depicts a side view of a stackable divisible container dimensioned in in accordance with the Fibonacci Sequence that permits easier removal of mature growth in accordance with the invention.

FIG. 5C depicts a perspective view of a stackable divisible container dimensioned in in accordance with the Fibonacci Sequence that permits the complete removal of mature growth used in accordance with the invention in accordance with the invention.

FIG. 5D depicts an exploded perspective view of a stackable divisible container dimensioned in in accordance with the Fibonacci Sequence that permits the complete removal of mature growth in accordance with the invention.

FIG. 6A depicts a perspective view of an alternative configuration of the divisible container dimensioned in accordance with the Fibonacci Sequence which permits the complete removal of mature growth used in accordance with the invention.

FIG. 6B depicts a perspective view of the internal support system used to secure a removable faceplate in an alternative configuration of the divisible container dimensioned in accordance with the Fibonacci Sequence that permits the complete removal of mature growth used in accordance with the invention.

FIG. 6C depicts a perspective view of the removable (and divisible) faceplate in an alternative configuration of the divisible container dimensioned in accordance with the Fibonacci Sequence which permits the complete removal of mature growth used in accordance with the invention.

FIG. 6D depicts a top exploded view of a removable and divisible faceplate in an alternative configuration of the divisible container dimensioned in accordance with the Fibonacci Sequence which permits the complete removal of mature growth used in accordance with the invention.

FIG. 6E depicts an exploded view of an alternative configuration of the divisible container dimensioned in accordance with the Fibonacci Sequence that permits the complete removal of mature growth used in accordance with the invention.

FIG. 7 depicts a top view example of a rack-and-pinion system for revolving plant receptacles within a container that may be used in accordance with one embodiment of the invention.

FIG. 8A depicts a perspective view of the internal baffling system that forms an aqueous nutrient solution reservoir that can be used for nutrient delivery in accordance with the invention.

FIG. 8B depicts a side view of the internal baffling system that forms an aqueous nutrient solution reservoir that can be used for nutrient delivery in accordance with the invention.

FIG. 8C depicts a back view of the internal baffling system that forms an aqueous nutrient solution reservoir that can be used for nutrient delivery in accordance with the invention.

FIG. 8D depicts a detailed view of the internal baffling system that forms an aqueous nutrient solution reservoir that can be used for nutrient delivery in accordance with the invention.

FIG. 9A depicts a front view of an air delivery system that can be used in accordance with the invention.

FIG. 9B depicts a side view of an air delivery system that can be used in accordance with the invention.

FIG. 9C depicts a perspective view of an air delivery system that can be used in accordance with the invention.

FIG. 9D depicts a detailed view of an air delivery system that can be used in accordance with the invention.

FIG. 9E depicts a detailed view of an air delivery system that can be used in accordance with the invention.

FIG. 10A depicts a front view of an aqueous nutrient delivery system that can be used in accordance with the invention.

FIG. 10B depicts a side view of an aqueous nutrient delivery system that can be used in accordance with the invention.

FIG. 10C depicts a perspective view of an aqueous nutrient solution delivery system that can be used in accordance with the invention.

FIG. 10D depicts a detailed view of an aqueous nutrient solution delivery system that can be used in accordance with the invention.

FIG. 11A depicts the general flow of aqueous nutrient solution through the aerohydroponic system with stackable, divisible containers to be used in accordance with aerohydroponic system of the invention.

FIG. 11B depicts the detailed flow of aqueous nutrient solution through the aerohydroponic system with stackable, divisible containers to be used in accordance with aerohydroponic system of the invention.

FIG. 11C depicts the general flow of air through the aerohydroponic system with stackable, divisible containers to be used in accordance with aerohydroponic system of the invention.

FIG. 11D depicts the detailed flow of air through the aerohydroponic system with stackable, divisible containers to be used in accordance with aerohydroponic system of the invention.

FIG. 12A depicts a back view of an example of a mounting system for the stackable, divisible containers that can be used in be used in accordance with aerohydroponic system of the invention.

FIG. 12B depicts a side view of an example of a mounting system for the stackable, divisible containers that can be used in be used in accordance with aerohydroponic system of the invention.

FIG. 12C depicts a perspective view of an example of a mounting system for the stackable, divisible containers that can be used in be used in accordance with aerohydroponic system of the invention.

FIG. 12D depicts a double sided mounting bracket used in the mounting system for the stackable, divisible containers that can be used in be used in accordance with aerohydroponic system of the invention.

FIG. 12E depicts a single sided mounting bracket used in the mounting system for the stackable, divisible containers that can be used in be used in accordance with aerohydroponic system of the invention.

FIG. 12F depicts a perspective view of an example of an internal mounting system for the stackable, divisible containers that can be used in be used in accordance with aerohydroponic system of the invention.

FIG. 12G depicts a perspective view of an example of an internal mounting system for the stackable, divisible containers that can be used in be used in accordance with aerohydroponic system of the invention.

FIG. 13A depicts a perspective view of an example of a control unit that can be used in accordance with aerohydroponic system of the invention.

FIG. 13B depicts a front view of an example of a control unit that can be used in accordance with aerohydroponic system of the invention.

FIG. 13C depicts a side view of an example of a control unit that can be used in accordance with aerohydroponic system of the invention.

FIG. 13D depicts a perspective view of an example of a control unit that can be used in accordance with aerohydroponic system of the invention.

FIG. 14A depicts a front view of an example of a photo radiation unit that can be used in accordance with aerohydroponic system of the invention,

FIG. 14B depicts a side view of an example of a photo radiation unit that can be used in accordance with aerohydroponic system of the invention.

FIG. 14C depicts a perspective view of an example of a photo radiation unit that can be used in accordance with aerohydroponic system of the invention.

FIG. 14D depicts side and perspective views of an example of a photo radiation unit that can be used in accordance with aerohydroponic system of the invention.

FIG. 14E depicts side and perspective views of an example of a photo radiation unit that can be used in accordance with aerohydroponic system of the invention.

FIG. 15A depicts a detailed view of an example of the CNC track system that can be used in accordance with aerohydroponic system of the invention.

FIG. 15B depicts a front view of an example of the CNC track system that can be used in accordance with aerohydroponic system of the invention.

FIG. 15C depicts a side view of an example of the CNC track system that can be used in accordance with aerohydroponic system of the invention,

FIG. 15D depicts a perspective view of an example of the CNC track system that can be used in accordance with aerohydroponic system of the invention.

FIG. 16A depicts a perspective view of a full aerohydroponic system of the invention with stackable, divisible containers, CNC track system, and photo radiation modules attached.

FIG. 16B depicts a side view of a full aerohydroponic system of the invention with stackable, divisible containers, CNC track system, and photo radiation modules attached.

FIG. 17A depicts an example of the construction of a spiral according to the Fibonacci Sequence.

FIG. 17B depicts an example of the Fibonacci sequence in nature (the arrangement of leaves and branches).

FIG. 17C depicts an example of the Fibonacci sequence in nature (the structure of a leaf).

FIG. 17D depicts an example of the Fibonacci sequence in nature (sunflower seed arrangement).

FIG. 17E depicts examples of the Fibonacci sequence in nature (pineapple structure).

FIG. 18A depicts a side view of a trapezoidal shaped container, demonstrating the structural stability of the stackable containers of the aerohydroponic system of the invention with a center of gravity below the mounting point.

FIG. 18B depicts a side view of a mirrored trapezoidal container demonstrating the structural stability of the stackable containers of the aerohydroponic system of the invention.

FIG. 19A is a side view of a trapezoidal shaped container demonstrating aerohydroponic growth with roots partially or wholly submerged in aqueous nutrient solution.

FIG. 19B is a front view of a trapezoidal shaped container demonstrating aerohydroponic growth with roots partially or wholly submerged in aqueous nutrient solution.

FIG. 20A depicts a front view of an example of a suspended/sheathed reflective photo radiation system that can be used in accordance with the aerohydroponic system of the invention.

FIG. 20B depicts a sectioned view of an example of a suspended/sheathed reflective photo radiation system that can be used in accordance with the aerohydroponic system of the invention.

FIG. 20C depicts a side view of an example of a suspended/sheathed reflective photo radiation system that can be used in accordance with the aerohydroponic system of the invention.

FIG. 21A depicts a side view of another example of an alternative photo radiation system that can he used in accordance with the aerohydroponic system of the invention.

FIG. 21B depicts a perspective view of another example of an alternative photo radiation system that can be used in accordance with the aerohydroponic system of the invention.

FIG. 21C depicts a detailed side view of another example of an alternative photo radiation system that can be used in accordance with the aerohydroponic system of the invention.

FIG. 21D depicts a detailed perspective view of another example of an alternative photo radiation system that can be used in accordance with the aerohydroponic system of the invention.

FIG. 22A depicts a side view of an example of an indoor system configuration in which the aerohydroponic system of the invention with stackable, divisible containers can be used.

FIG. 22B depicts a detailed side view example of an indoor system configuration in which the aerohydroponic system of the invention with stackable, divisible containers can he used.

FIG. 22C depicts a detailed side view example of an indoor system configuration in which the aerohydroponic system of the invention with stackable, divisible containers can be used.

FIG. 22D depicts a detailed side view example of an indoor system configuration in which the aerohydroponic system of the invention with stackable, divisible containers can he used.

FIG. 22E depicts a side view example of an indoor system configuration in which the aerohydroponic system of the invention with stackable, divisible containers can be used.

FIG. 22F depicts a detailed side view example of an indoor system configuration in which the aerohydroponic system of the invention with stackable, divisible containers can be used.

FIG. 22G depicts a top view example of an indoor system configuration in which the aerohydroponic system of the invention with stackable, divisible containers can be used.

FIG. 22H depicts a detailed side view example of an indoor system configuration in which the aerohydroponic system of the invention with stackable, divisible containers can he used.

FIG. 23A depicts perspective view of an example of how the aerohydroponic system of the invention with stackable, divisible containers can be used system configured for use inside a shipping container.

FIG. 23B depicts a transparent perspective view of an example of how the aerohydroponic system of the invention with stackable, divisible containers can be used system configured for use inside a shipping container,

FIG. 24A depicts a side view of an example of how the aerohydroponic system of the invention with stackable, divisible containers configured for use inside a warehouse.

FIG. 24B depicts a transparent side view of an example of how the aerohydroponic system of the invention with stackable, divisible containers configured for use inside a warehouse.

FIG. 25A depicts a detailed perspective view of examples of outdoor system configurations for the aerohydroponic system of the invention with stackable, divisible containers.

FIG. 25B depicts a perspective view of examples of outdoor system configurations for the aerohydroponic system of the invention with stackable, divisible containers.

FIG. 26A depicts a front view of an example of the aerohydroponic system of the invention with stackable, divisible containers system configured f©r use on a roof of a building or other structure.

FIG. 26B depicts a top view of an example of the aerohydroponic system of the invention with stackable, divisible containers system configured for use on a roof of a building or other structure.

FIG. 26C depicts a perspective view of an example of the aerohydroponic system of the invention with stackable, divisible containers system configured for use on a roof of a building or other structure.

FIG. 26D depicts a side view of an example of the aerohydroponic system of the invention with stackable, divisible containers system configured for use on a roof of a building or other structure,

FIG. 27A depicts a transparent front view of a complete aerohydroponic system with vertical, stackable, divisible, and removable containers according to the invention.

FIG. 27B depicts a transparent side view of a complete aerohydroponic system with vertical, stackable, divisible, and removable containers according to the invention.

FIG. 27C depicts transparent perspective view of a complete aerohydroponic system with vertical, stackable, divisible, and removable containers according to the invention.

### DETAILED DESCRIPTION

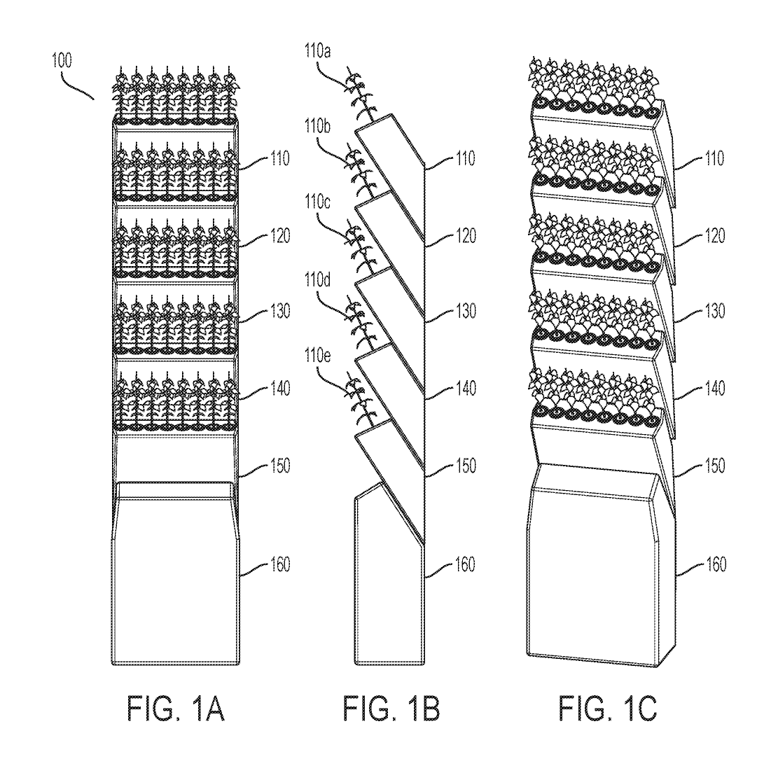

FIGS. 1A, 1B, and 1C depict front, side and perspective views of a complete vertical, stackable aerohydroponic system 100 according to the invention. It includes at least a plurality of stackable containers 110, 120, 130, 140, and 150 structured to permit air and aqueous nutrient delivery through the stacked containers when connected vertically to a system 160 for air and aqueous nutrient delivery. Although FIGS. 1A, 1B, and 1C depict five levels of stackable containers, more or less can be used, depending upon stability considerations and space constraints in which the system is deployed. The containers house plants 110a, 110b, 110c, 110d, 110e and are and vertically connected in fluid communication with each other. More or fewer plants than what is depicted can be included. The containers 110, 120, 130, 140, and 150 are connected in fluid communication with an air and aqueous nutrient delivery system 160.

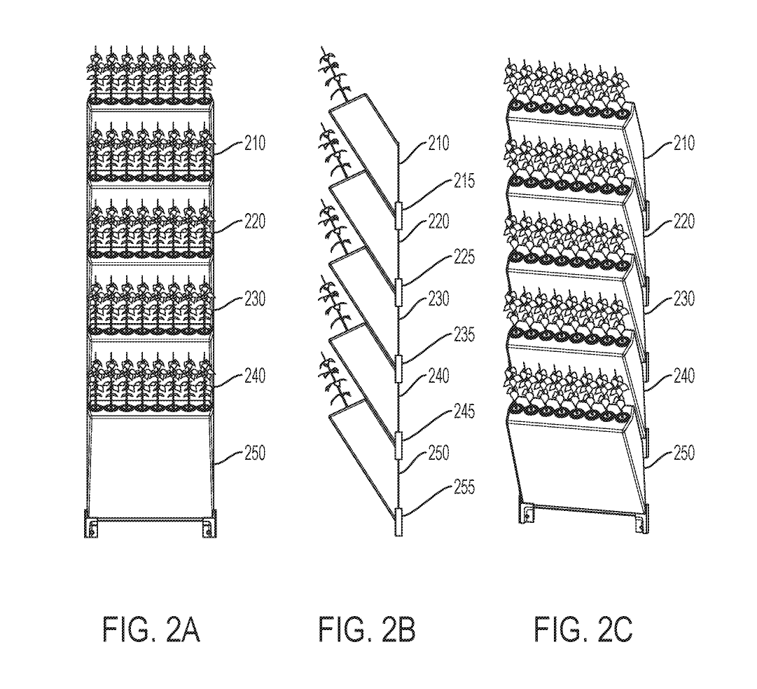

FIGS. 2A, 2B, and 2C are front, side, and perspective views of examples of the stackable modular aerohydroponic containers 210, 220, 230, 240, 250, with bracket supports 215, 225, 235, 245, and 255 for mounting and system stability.

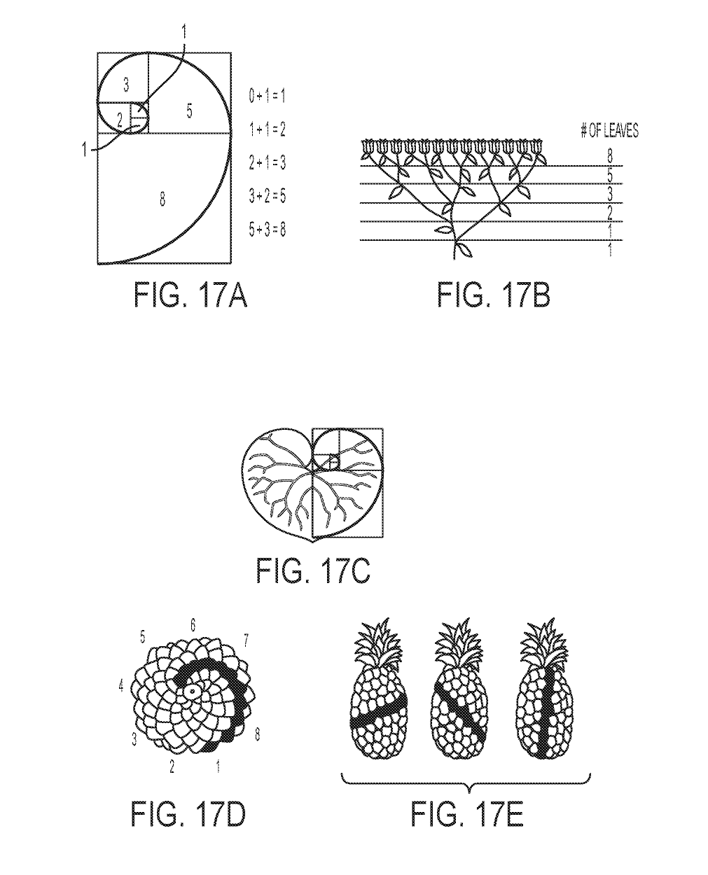

The Fibonacci numbers are the sequence of numbers {Fₙ} from n=1 to infinity defined by the linear recurrence equation: Fₙ=(Fₙ-1)+(Fₙ-2) with F1=F2=1. As a result of the definition (1), it is conventional to define F0=0. The Fibonacci numbers for n=1,2, . . . are 1, 1, 2, 3, 5, 8, 13, 21. FIG. 17A depicts a Fibonacci Spiral. Binet's Fibonacci number formula, another (closed) form of this equation, solves for the n^{th} member of the sequence: Fₙ=((φⁿ)−(−φ)̂⁻ⁿ))/√5. When squares are made with widths using the Fibonacci sequence, the squares fit neatly in a spiral. The Fibonacci spiral is an approximation of the golden spiral created by drawing circular arcs connecting the opposite corners of squares. It is a logarithmic spiral whose growth factor is φ (Phi), or the “golden ratio.” A golden spiral gets wider by a factor of φ for every quarter turn it makes.

FIGS. 17B, 17C, 17D, and 17E depict examples of the Fibonacci sequence in nature. These examples demonstrate how each petal/leaf/seed/etc., is placed at φº (Phiº or ≈0.618034°) per turn (of a 360° circle) allowing for the best possible exposure to photo radiation and other factors (like wind and wildlife). It is advantageous for a horticultural system to follow the same pattern.

Examples of the Fibonacci Sequence in nature appear frequently (on both the micro and macro scale), from the leaf arrangement in plants (FIG. 17B), to the pattern of the florets of a flower, the bracts of a pinecone, or the scales of a pineapple. FIG. 17E demonstrates a Fibonacci Spiral that approximates the golden spiral using quarter-circle arcs inscribed in squares of integer Fibonacci-number side, shown for square sizes 1, 1, 2, 3, 5, and 8. FIG. 17B demonstrates the Fibonacci sequence in the instance of leaf arrangement and branching. The leaves on this plant are arranged in a pattern to permit optimum exposure to sunlight. By following the Fibonacci Sequence, the plant is able to maximize the space for each leaf and the average amount of light falling on each one. Branching plants also exhibit Fibonacci numbers. Again, this design provides the best physical accommodation for the number of branches, while maximizing sun exposure. FIG. 17C demonstrates how other plant life (aside from flora) leverages the Fibonacci sequence to maximize the efficiency of light exposure during the growth phase of plants. FIG. 17D depicts how sunflowers implement a Golden Spiral seed arrangement. This provides a biological advantage because it maximizes the number of seeds that can be packed into a seed head. FIG. 17E demonstrates the case of tapered pineapples (or pinecones), utilizing a double set of spirals—one going in a clockwise direction and one in the opposite direction. When these spirals are counted, the two sets are found to be adjacent Fibonacci nutribers.

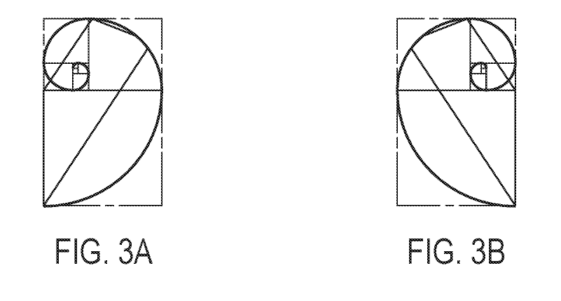

There are advantages to dimensioning the containers used in an aerohydroponic horticultural system according to the Fibonacci Sequence to provide the superior accommodation for plant growth in the vertical direction. FIGS. 3A and 3B depict side views of an example of a container dimensioned in accordance with the Fibonacci Sequence in accordance with the invention. The containers dimensioned according to the Fibonacci Sequence can be made into different shapes.

The stackable, removable, and divisible containers used with the invention can take a variety of different shapes and be dimensioned according to the Fibonacci Sequence regardless of the shape chosen.

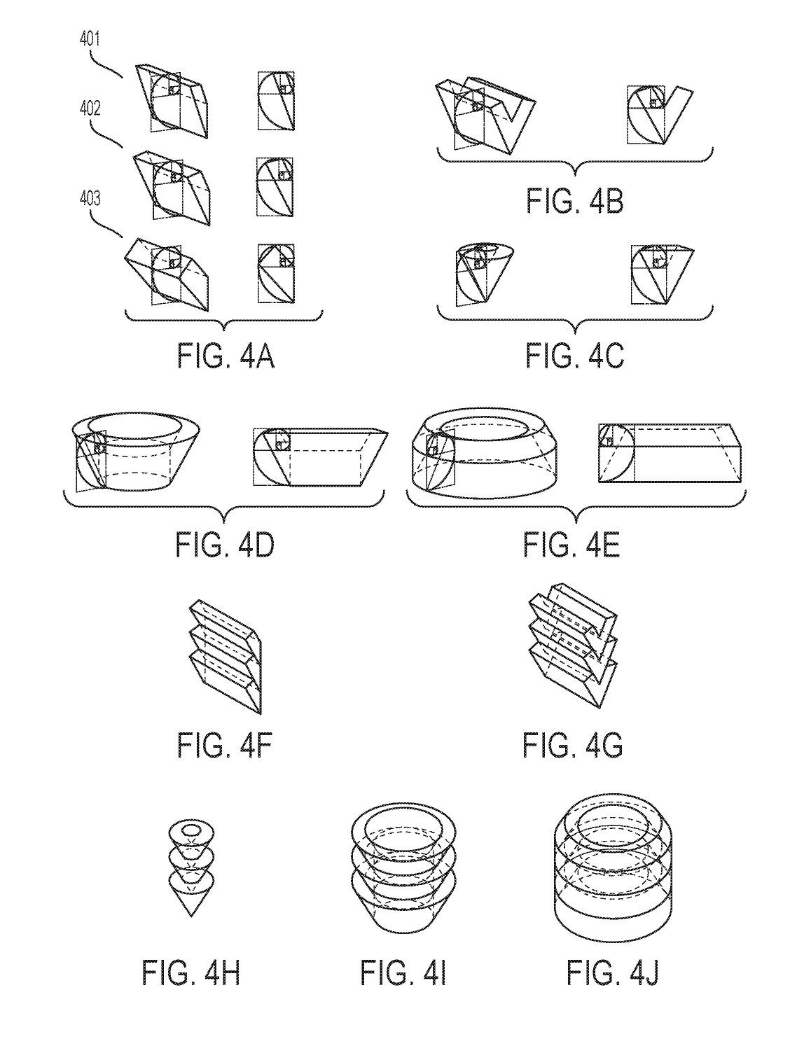

FIGS. 4A-J demonstrate examples of containers dimensioned in accordance with the Fibonacci Sequence and in accordance with the invention. The containers are, as shown in FIG. 4A, dimensioned according to the Fibonacci Sequence but may take various forms 401, 402, 403 (as long as the dimensions conform to the curve generated by the Fibonacci Spiral). This concept can be applied to several different shapes, including: FIG. 4A trapezoidal, FIG. 4B mirrored trapezoidal, FIG. 4C conical, FIG. 4D circular, and FIG. 4E inverted circular. Furthermore, each of these shapes can be vertically stacked as demonstrated in FIG. 4F stacked trapezoidal, FIG. 4G stacked mirrored trapezoidal, FIG. 4H stacked conical, FIG. 4I stacked circular, and FIG. 4J stacked inverted circular.

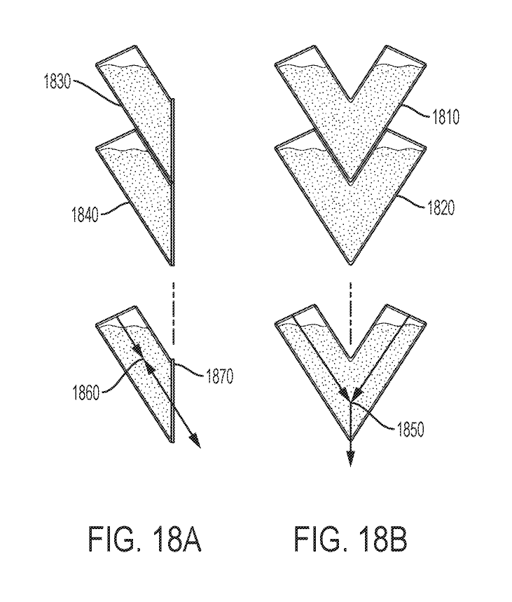

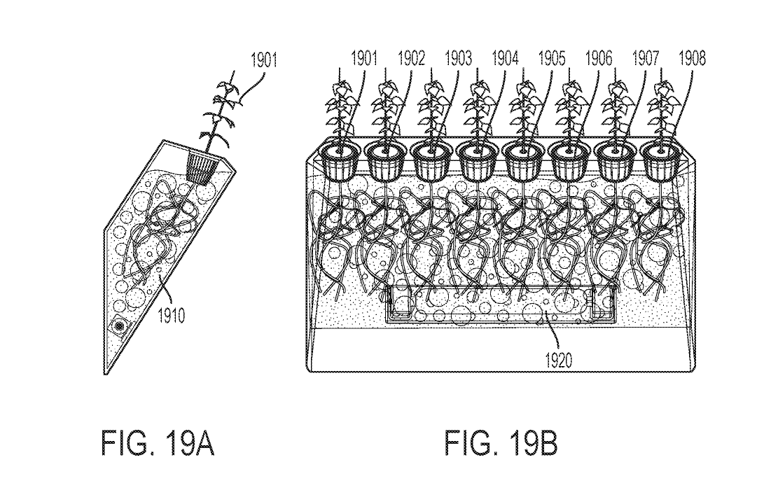

Stackable containers offer advantages of permitting plants to grow more naturally and vertically. FIGS. 18A and 18B is an example depicting front and side views of the stability of the stackable containers 1830 and 1840 and 1810 and 1820 that can be used the aerohydroponic system of the invention with a center of gravity 1860 and 1850 below the mounting point 1870 for the containers when filled with fluid.

Although stackable containers offer advantages in growing and stability, removal of mature plant growth in horticultural systems with stackable containers to permit easy harvesting and/or transplantation of mature growth without undue disruption of the entire system has been difficult to overcome in prior systems. The stackable containers of the present system are individually removable from their supporting structure and divisible at the center of the container to permit easy removal of mature growth without disrupting the root system.

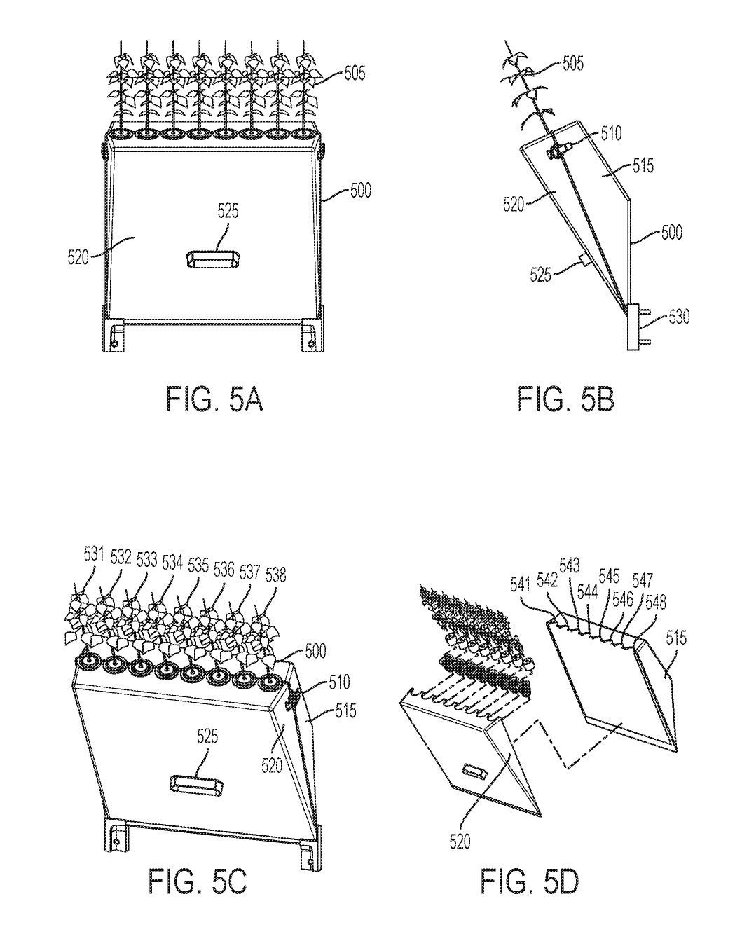

FIG. 5A is a front view example of a removable stackable divisible container 500 dimensioned in in accordance with the Fibonacci Sequence that is used in accordance with the invention. FIG. 5B is a side view of a stackable divisible container 500 dimensioned in in accordance with the Fibonacci Sequence that can be used in accordance with the invention. FIG. 5C is a perspective view of a stackable divisible container 500 dimensioned in in accordance with the Fibonacci Sequence that can be used in accordance with the invention. FIG. 5D is an example of an exploded view of the same container.

The container 500 contains two portions 515 and 520 connected by a connector 510 and uses a latching mechanism 510 to connect the divisible portions 515 and 520 to permit removal of plant growth 531, 532, 533, 534, .535, 536, 537, 538 for harvesting. The two portions 515 and 520 of the container also maintain a watertight seal via a tongue and groove or other suitable mating (not pictured). The latching mechanism 510 can be any mechanism that can releasably secure the first and second divisible portions 510 and 520 of the container 500 so that the container does not come apart until the latching mechanism 510 is disengaged to release the first and second divisible portions 510 and 520 of the container. A channel 525 permits the flow of aqueous nutrient solution between stacked containers. The plant growth 531, 532, 533, 534, 535, 536, 537, and 538 can be further arranged into receptacles 541, 542, 543, 544, 545, 546, 547 and 548 that fit within the divisible portions 510 and 520 of the container 500. The receptacles are preferably circular and cylindrically shaped but could be other shapes as well. Although eight receptacles are depicted in FIGS. 5A, 5B, 5C, and 5D, fewer or greater numbers of receptacles could be used. FIG. 5D is an example of an exploded perspective view that depicts how the divisible container 500 permits the complete removal of mature growth used in accordance with the invention without damaging plant roots or disturbing nutrient delivery to other plants. The container 500 can be used with aeroponic, hydroponic, or aerohydroponic systems.

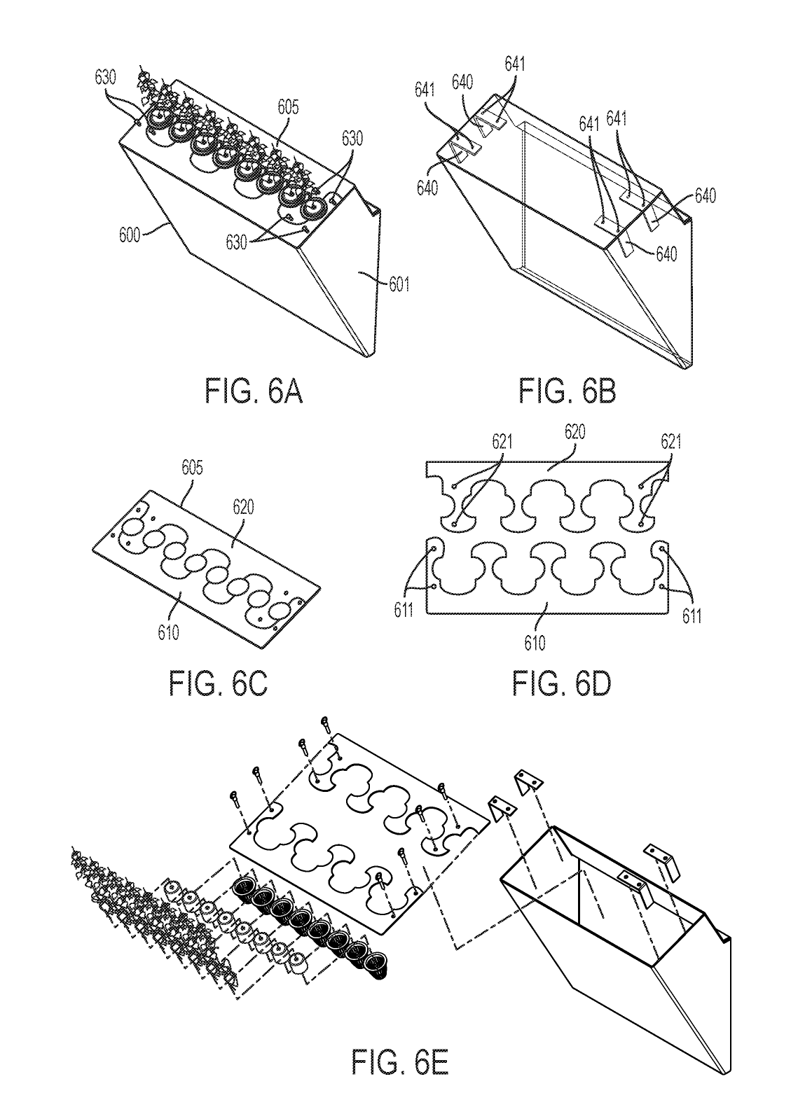

FIGS. 6A-D depict examples of an alternative configuration of a divisible container that permits the complete removal of mature growth used in accordance with the invention without damaging plant roots or disturbing nutrient delivery to other plants. The container 600 has a main body 601 and a face plate 605 comprising the combination of two face plate portions: 610 and 620. The filet plate 605 sits on brackets 640 that are attached (welded, bolted, etc.) to the main body of the container 601. In the depicted instance, each faceplate sits on 4 brackets 640 (two on each side of the face plate), but more or less could be used. In FIGS. 6A-D, each faceplate is secured by clevis pins or unthreaded bolts 641 that secure the brackets and the faceplate through holes in the faceplate 605. Alternative ways to connect the two faceplate portions 610 and 620 can also be used. This alternative configuration also permits the complete removal of mature growth used in accordance with the invention without damaging plant roots or disturbing nutrient delivery to other plants.

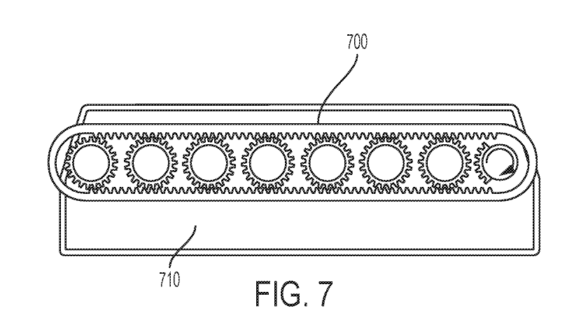

FIG. 7 is an example of a rack-and-pinion system 700 having a faceplate 710 that can be used for revolving plant receptacles within a container in accordance with one embodiment of the invention.

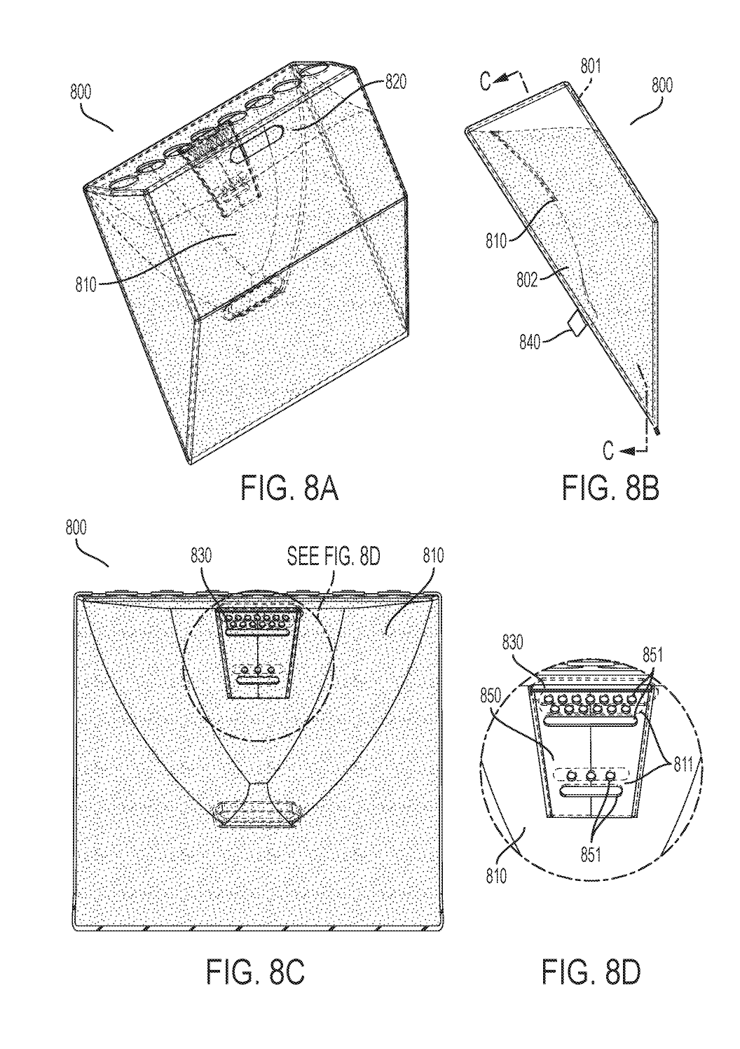

FIGS. 8A-8D depict perspective, side, and front, and detailed views of an example of a container 800 with internal baffling 810 that forms an aqueous nutrient solution reservoir 820, the evacuation member 840 of a superior container mates to the opening 801 of a subsequent container, permitting the introduction of the aqueous nutrient solution 820 to the subsequently stacked container. The baffling 810 comprises an adjustable mechanism 830 to regulate the level of the nutrient solution reservoir 820 and terminates in evacuation member 840. As shown in FIG. 8D, the adjustable mechanism 830, comprises a plate 850 with orifices 851 that fits against the baffling 810 and its regulative orifices 811 such that the plate orifices and regulative orifices 851 can be aligned to increase flow (and decrease nutrient solution reservoir levels) or misaligned to decrease flow (and raise nutrient solution reservoir levels). The adjustable mechanism can be operated either manually or through a motorized mechanism. Other configurations designed to increase or decrease flow may also be used.

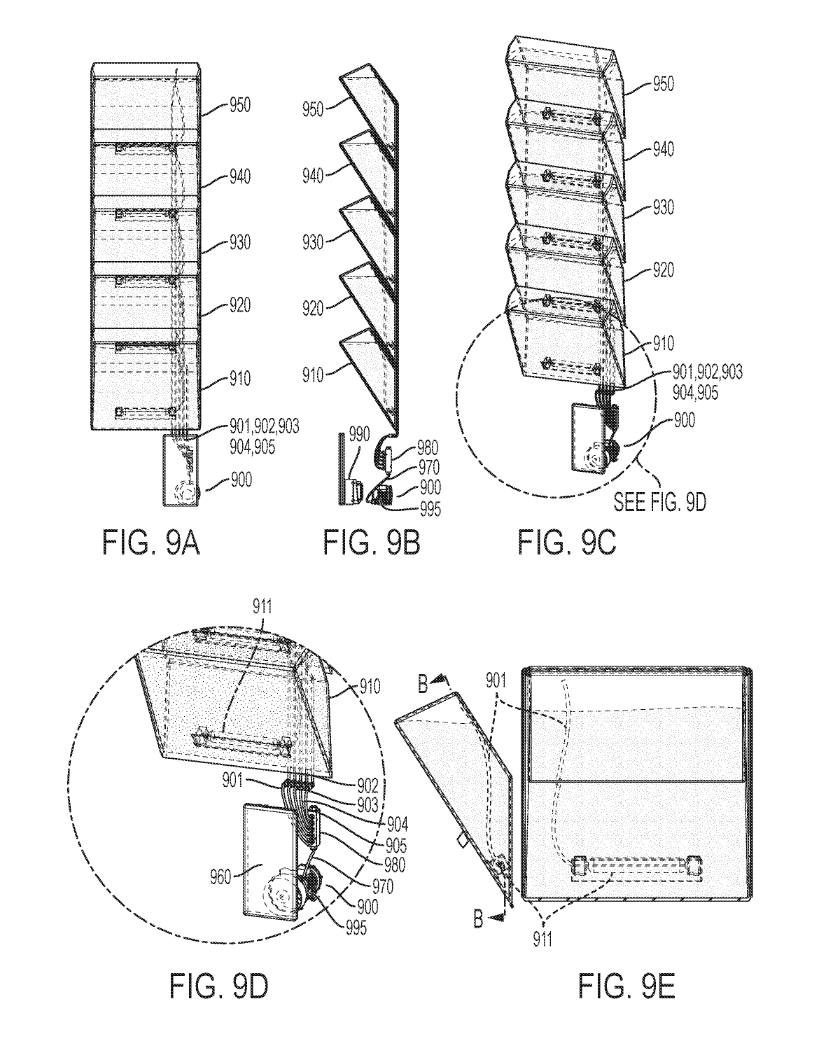

FIGS. 9A-E depict front, side, and perspective views of an example of an air delivery system 900 that can be used in accordance with the invention. FIG. 9D isolates the system 900 as connected to the first container 910. The air delivery system 900 is connected to containers, 910, 920, 930, 940, and 950 via conduit tubes 901, 902, 903, 904, and 905. Fewer or greater numbers of conduit tubes and containers could be used. Preferably, the containers are releasable, divisible and contain receptacles for plant growth that facilitate easy removal of mature plant growth. The air delivery system may further comprise an air filtration system 960.

In FIG. 9D the air delivery system 900 takes ambient air, compresses it and passes it through conduits to gaseous diffuser 911. More or fewer conduits can be used. Multiple diffusers can be used to correspond to each conduit 901, 902, 903, 904, 905 and each diffuser should be housed and submerged in a container unit. If more than one container is used, the conduits must first feed a manifold 980 that distributes the main line 970 of compressed air into a series of new conduits 901, 902, 903, 904, and 905 that feed each individual container unit. Prior to passing through the compressor 995, the air may first be drawn through a filter 960 by a fan 990 and may additionally be supplemented by other gasses (oxygen, nitrogen, ozone). Air filtration may further comprise a dehumidification unit (not pictured) wherein the water separated from the air and is channeled to the main aqueous nutrient solution tank While the air is channeled to the compressor (pump) 995.

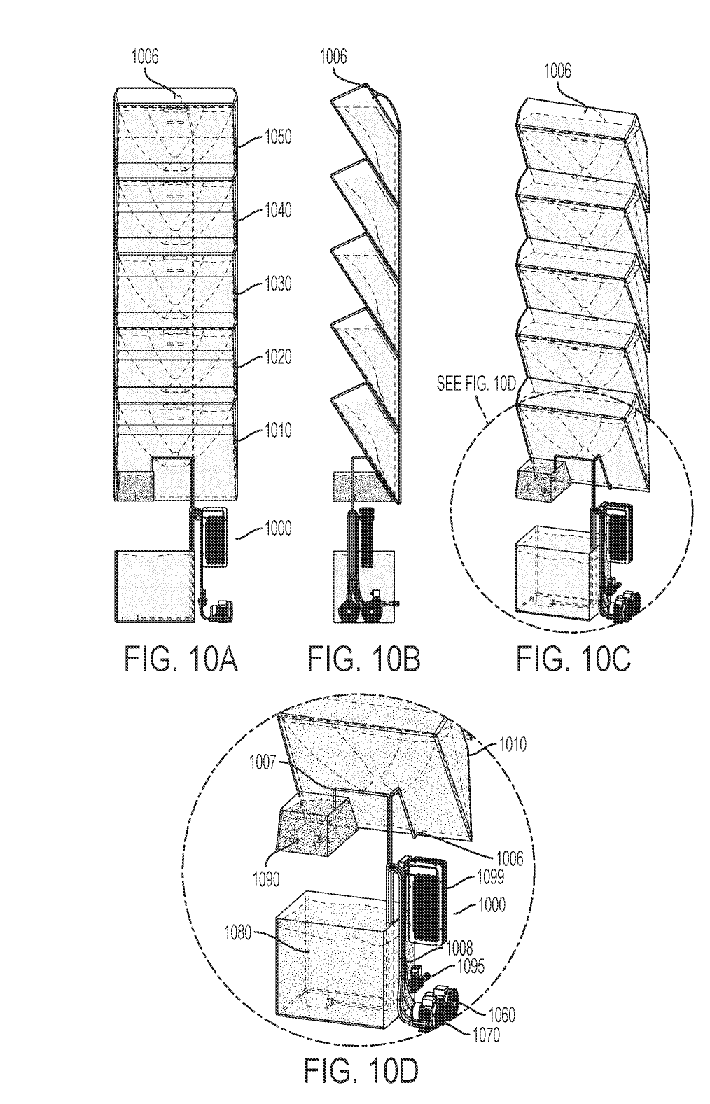

FIGS. 10 A-D depict front, side, and perspective views of an example of an aqueous nutrient solution delivery system 1000 that can be used in accordance with the invention. The system 1000 is directly connected to the first container 1050 via conduit 1006. The aqueous nutrient solution delivery system 1000 is indirectly connected to containers, 1040, 1030, 1020, and 1010 via evacuation members mated to subsequent intake apertures. Fewer or greater numbers of conduit tubes and containers could be used. Preferably, the containers are releasable, divisible and contain receptacles for plant growth that facilitate easy removal of mature plant growth. The aqueous nutrient solution delivery system 1000 comprises a pump 1060, a conduit 1006 that transports the nutrient solution from the aqueous nutrient solution reservoir 1080 to the uppermost container 1050. The aqueous nutrient solution system 100 further comprises a concentrated nutrient reservoir 1090, a conduit 1007 connecting the concentrated nutrient reservoir 1090 to the nutrient solution reservoir 1080 via a pump 1070. The aqueous nutrient solution system 1000 further comprises a solenoid valve 1095 and a conduit 1008 that connects an external water source (not pictured) to the nutrient solution reservoir 1080. The aqueous nutrient solution system 1000 further comprises a dehumidification unit 1099 that draws moisture from the ambient environment and deposits water into the aqueous nutrient solution reservoir 1080.

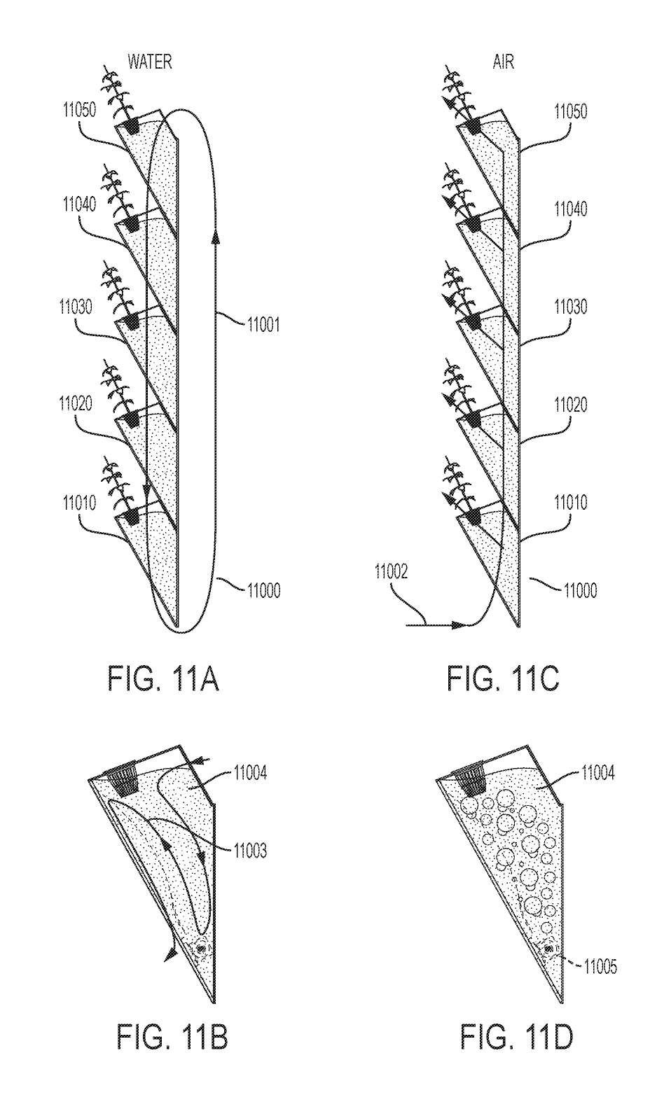

FIGS. 11A-D depict aqueous nutrient solution and air flows through the aerohydroponic system with stackable, divisible containers to be used in accordance with aerohydroponic system of the invention. FIGS. 11A-D depict aqueous nutrient solution and air flows through the aerohydroponic system 11000 in FIG. 11C with stackable, divisible containers to be used in accordance with aerohydroponic system of the invention. FIGS. 11B and 11D represent the system 11000 as a single container for illustration purposes. The aerohydroponic system 11000 includes containers, 11010, 11020, 11030, 11040, and 11050. The flow of aqueous nutrient solution 11001 is from the topmost container 11050 and flows (through internal baffling and channeling 11003) to the bottom most container 11010. The flow of air 11002 is from the air pump (not pictured) to each container (11010, 11020, 11030, 11040, and 11050). In each container, air passes through the gaseous diffusion apparatus 11005 and flows through the nutrient solution 11004 providing enhanced gaseous exchange with the root systems of plants growing in the system. Similarly, in each container the aqueous nutrient solution follows the general path 11003 and flows to each subsequently stacked container. Furthermore, the gaseous diffusion within the nutrient solution further encourages movement and circulation of the aqueous nutrient solution fluid (and pulverization/atomization of dissolved nutrients) within the system and introduces filtered air into the ambient environment (and enhanced airflow over the supported plant matter).

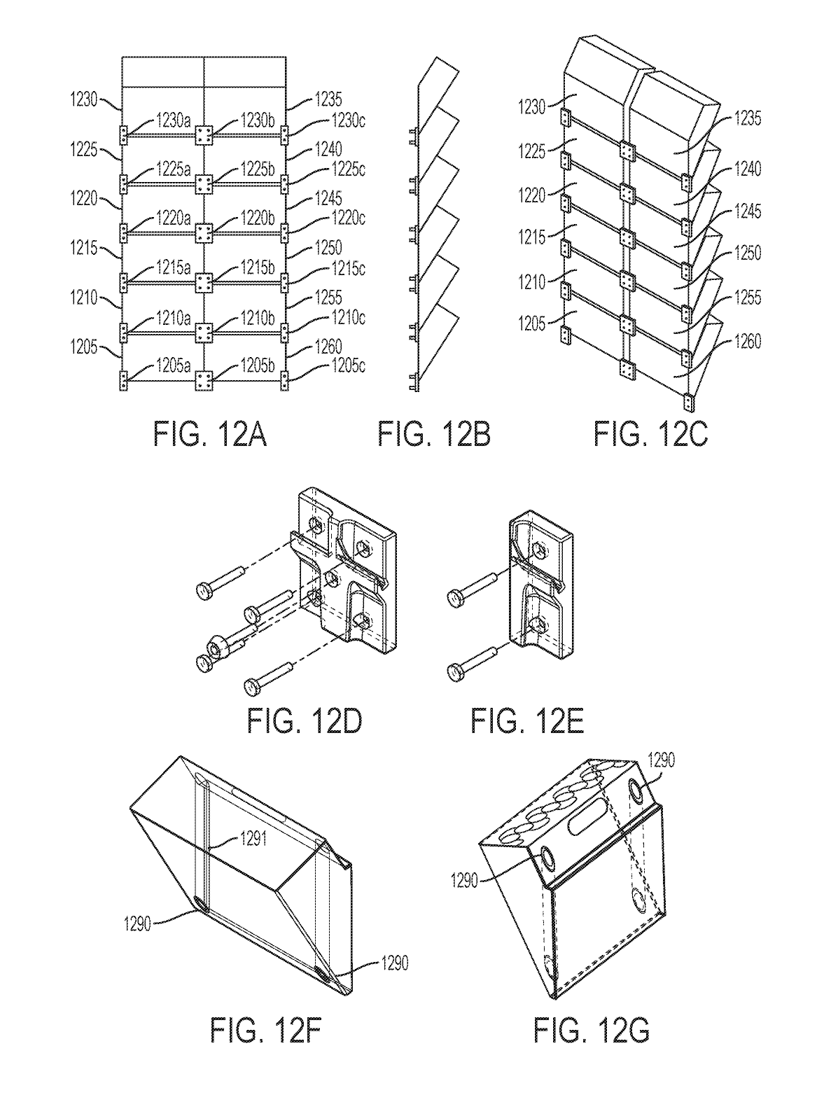

FIG. 12A-E depict examples of a mounting system for the stackable, divisible containers that can he used in he used in accordance with aerohydroponic system of the invention. The mounting system permit vertically mounting the containers, which are engageable with each other, to permit fluid communication between the conduits of the containers. FIG. 12A depicts a back view of the mounting system for containers 1205, 1210, 1215, 1220, 1225, 1230, 1235, 1240, 1245, 1250, 1255, and 1260 connectable to a wall or other support at points 1205a, 1205b, 1205c, 12100a, 1210b, 1210c, 1215a, 1215b, 1215c, 1220a, 1220b, 1220c, 1225a, 1225b, 1225c, 1230a, 1230b, and 1230c.

FIG. 12B depicts a side view and FIG. 12C a perspective view of the mounting system of FIG. 12A. FIGS. 12D and 12E depict detailed views of the fasteners used at a points 1205a, 1205b, 1205c, 12100a, 1210b, 1210c, 1215a, 1215b, 1215c, 1220a, 1220b, 1220c, 1225a, 1225b, 1225c, 1230a, 1230b, and 1230c. The fasteners can be self-supporting or embedded in or bolted to a wall and can include a mating hanger adapted for fastening to a wall; wherein the fasteners fastened to the back of said container units engage with the wall fasteners so that each said container unit is supported by the wall and lower container units do not have to support the weight of overlying container units; the container units are removable from the wall by lifting up the container units and disengaging the container unit fasteners from the wall fasteners. FIG. 12F and FIG.12G depict an alternative configuration where internal stanchions 1290 are used to provide support to a stack of aerohydroponic containers and also permit the use of internal plumbing systems for both the aqueous nutrient solution and air conduits. In this construct one stanchion includes an orifice 1291 to allow the air conduit to connect to the gaseous diffusion apparatus (not pictured). The stanchions 1290 are designed to accept a cylindrical support that passes through an entire stack of containers and is securable to the ground.

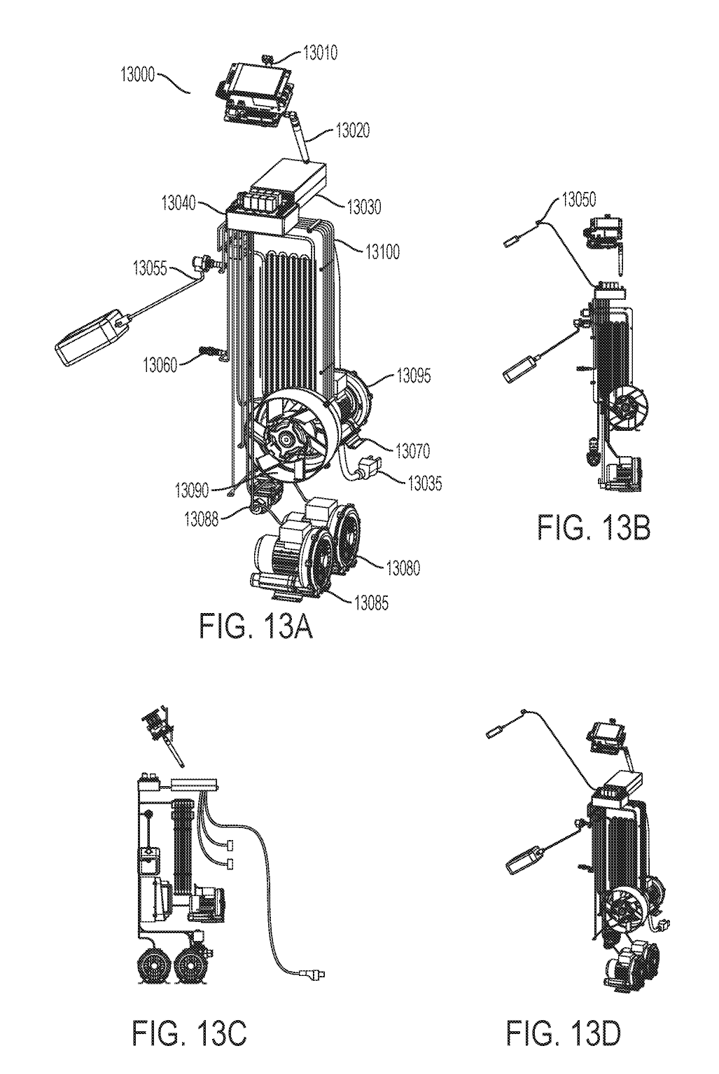

FIGS. 13A-D are different views of a control unit that can be used in accordance with aerohydroponic system of the invention. The control unit 13000 is centered on the central processing unit 13010 that comprises a processing unit, memory and user interface screen. The control unit 13000 further comprises a communications apparatus 13020 that allows the entire unit to be operated remotely and communicate system status. The control unit is powered by a power supply 13030 that communicates with a standard wall outlet 13035. The control unit 13000 controls the operation of various system functions through a series of relays 13040. These relays 13040 control the operation of the air pump 13095 (for the air delivery system), the air intake fan 13090, the aqueous nutrient solution delivery system pump 13080, the concentrated nutrient pump 13085, and the solenoid 13088 to introduce new water to the system. The control unit 13000 can activate the various devices controlled by the relays 13040 in response to (i) pre-programmed cycles; (ii) manual electronic requests (via the screen based user interface or remote application); (iii) changes in sensor readings from the pH/dissolved solid measurement sensor 13060, concentrated nutrient solution level indicator 13050, or aqueous nutrient solution level indicator 13055. Sensors can be placed in the containers that can be used to measure and store data of aqueous nutrient solution oxygen availability, aqueous nutrient solution nutrient levels (electrical conductivity), aqueous nutrient solution pH level, temperature, barometric pressure, light levels, humidity, carbon dioxide levels, aqueous nutrient solution cistern liquid level and concentrated aqueous nutrient solution cistern liquid level. The computing system can communicate the stored data to a computing device, control system functionality, and generate alerts.

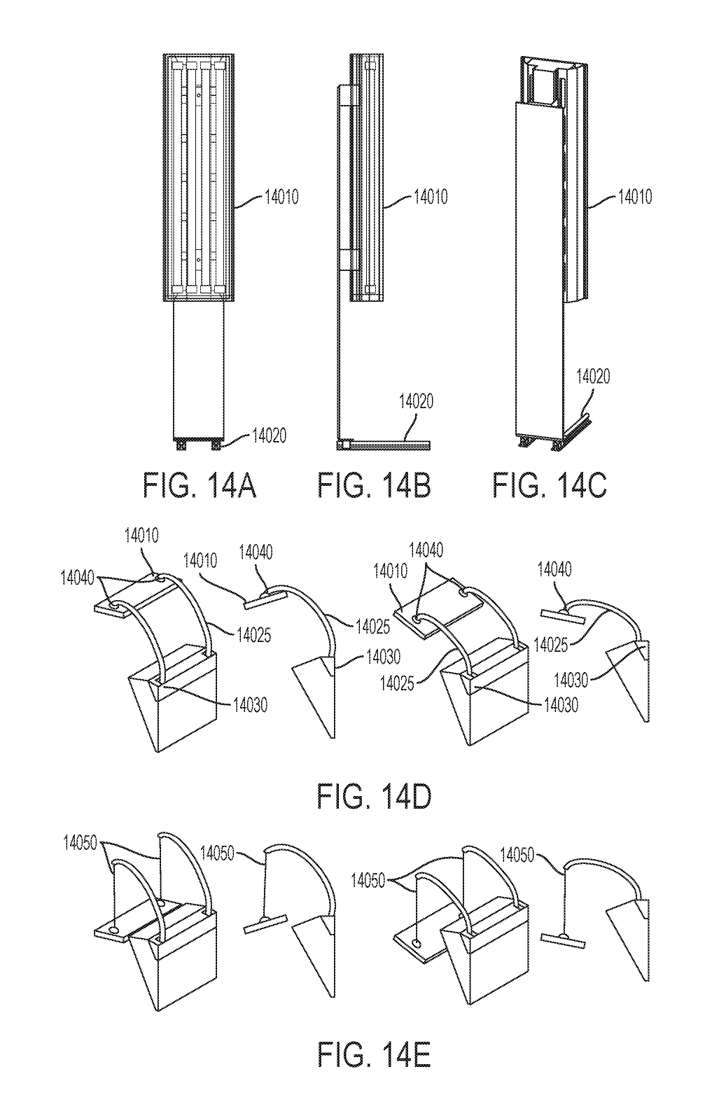

FIGS. 14A-E depict front, side, perspective, and detailed views of an example of a photo radiation unit that can be used in accordance with aerohydroponic system of the invention. The system comprises a photo radiation device (incandescent, fluorescent, halides, LED, etc.) 14010. In FIGS. 14 A-C a fluorescent implementation is shown. In this configuration, the system employs a track system 14020 to adjust/control the distance between the plant growth (not pictured) and the photo radiation device 14010. In FIGS. 14D and 14E, the photo radiation device 14010 is attached to movable arms 14025 that are anchored to a stack unit 14030. The joint(s) 14040 between the photo radiation device and these arms are pivotal and allow the photo radiation device 14010 to be angled towards/away from the plant growth (not pictured). Furthermore, these joints 14040 will also allow the extension/retraction of the photo radiation device 14010 from the pivotal arms 14050.

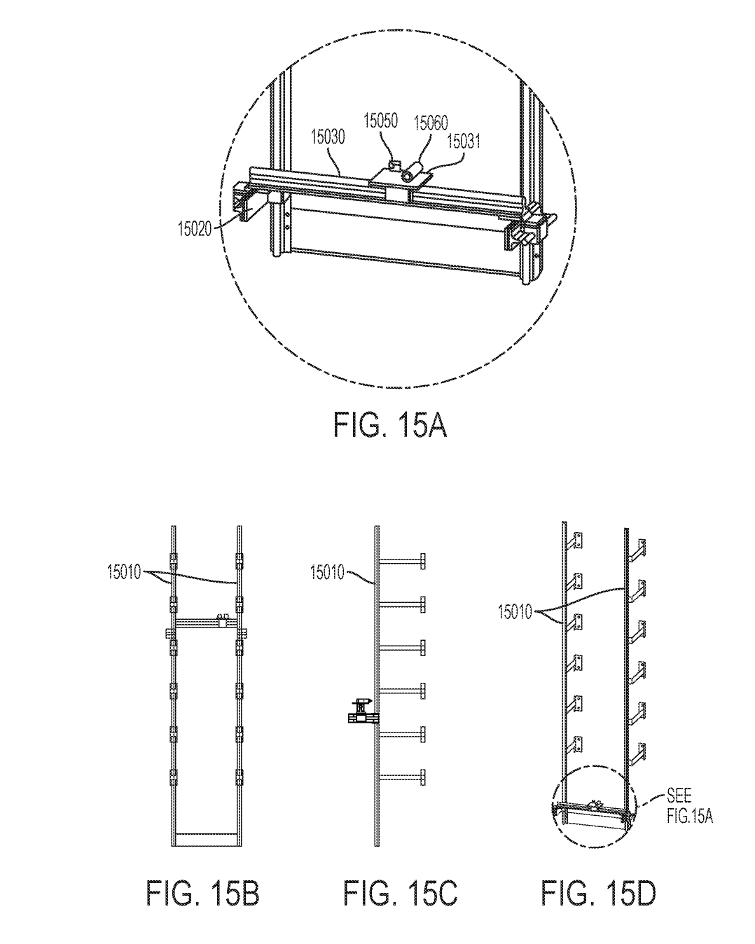

FIGS. 15A-D depict front, side, detailed, and perspective views of an example of the CNC track system that can be used in accordance with aerohydroponic system of the invention. The track system has a Y track 15010 integral to the vertical arrangement of containers which allows the movable boom 15020 to traverse the system in a Y direction, wherein the movable boom contains a X track 15030 that allows an apparatus 15031 attached to the boom to travel in an X direction and may contain a Z track that allows the attached apparatus to travel in a Z direction. It can include a mechanism to control deposit of at least one seed in holding at least one soilless growth medium housed in rigid cup-shaped receptacles. The track system also can contain cameras and other sensors 15050 to ascertain one or more of the following: canopy/growth temperature, leaf/growth thickness/size, stem diameter, canopy/growth color or leaf/growth wetness. The pruning system 15060 can utilize compressed air/water, laser radiation, saw or other cutting device to remove selected growth.

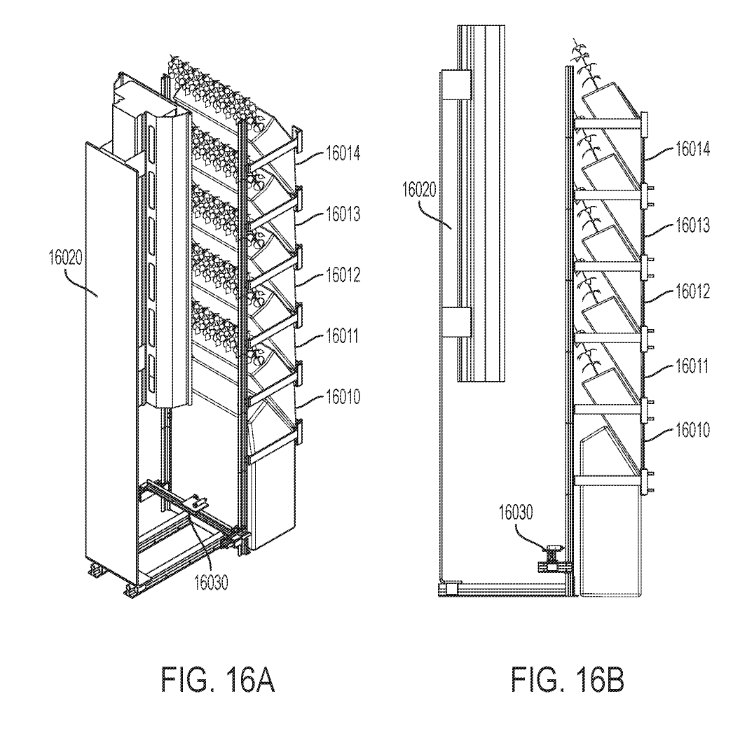

FIGS. 16A-B depict examples of perspective and side views of a fill aerohydroponic system 16020 of the invention with stackable, divisible containers (16010, 16011, 16012, 16013, 16014), with CNC track system 16030 and photo radiation 16020 modules attached.

The track system has a Y track integral to the vertical arrangement of containers which allows the movable boom to traverse the system in a Y direction, wherein the movable boom contains a X track that allows an apparatus attached to the boom to travel in an X direction and may contain a Z track that allows the attached apparatus to travel in a Z direction. It can include a mechanism to control deposit of at least one seed in holding at least one soilless growth medium housed in rigid cup-shaped receptacles. The track system also can contain cameras and other sensors to ascertain one or more of the following: canopy/growth temperature, leaf/growth thickness/size, stem diameter, canopy/growth color or leaf/growth wetness. It also can include a pruning system (not pictured) that can utilize compressed air/water, laser, radiation, saw or other cutting devices to remove selected growth.

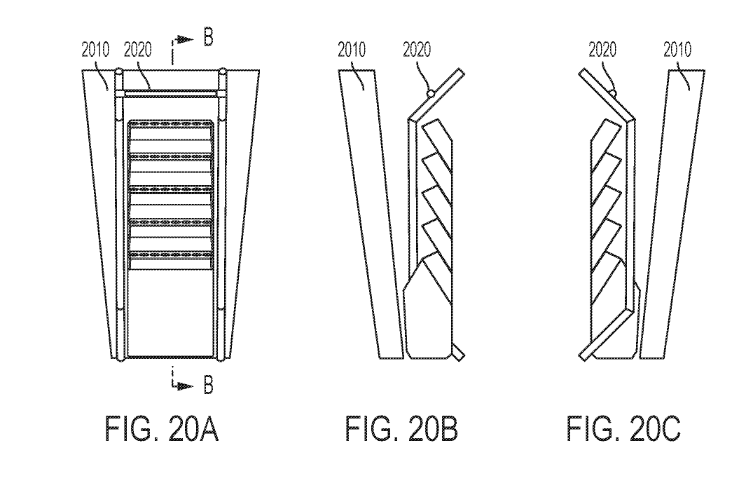

FIG. 20A-E depict front and side views of an example of a suspended/sheathed reflective photo radiation system that can be used in accordance with the aerohydroponic system of the invention. The sheathed reflective surface 2010 reflects light generated by a photo radiation apparatus 2020.

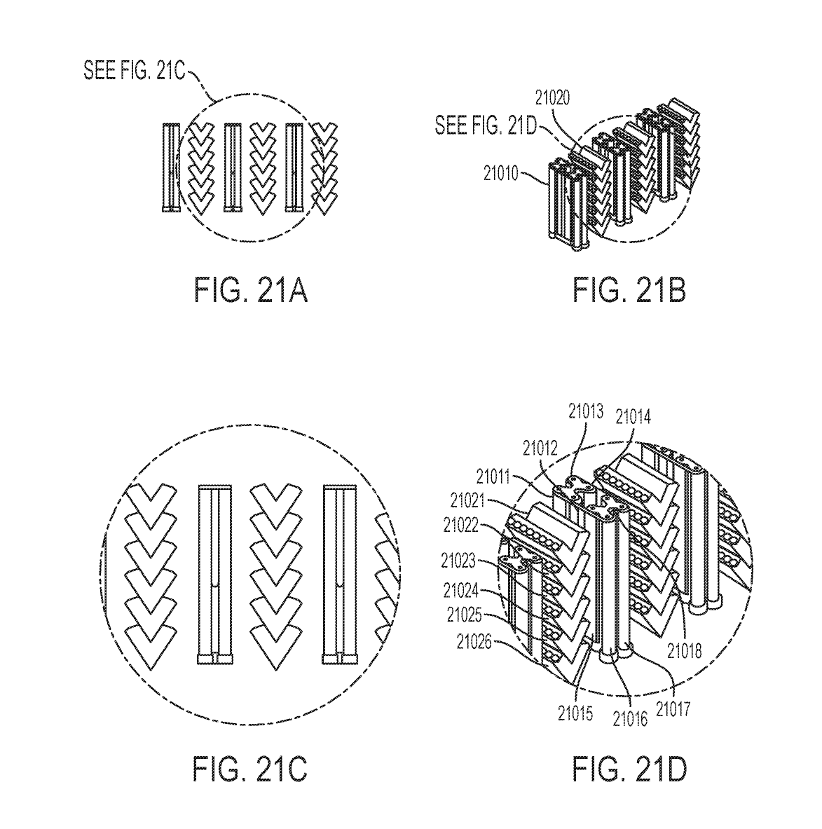

FIGS. 21A-D depict another example of an alternative photo radiation unit 2020 that can be used in accordance with the aerohydroponic system of the invention. In this configuration, lighting elements 21010 are vertically arranged and mounted on a ceiling and oriented to provide light for stacked units 21020. The lighting elements 21011, 21012, 21013, 21014, 21015, 21016, 21017, 21018 (for example, fluorescent tubes) are arranged parallel to the stack of containers 21020 (21021, 21022, 21023, 21024, 21025, 21026) and fully expose the containers to photo radiation.

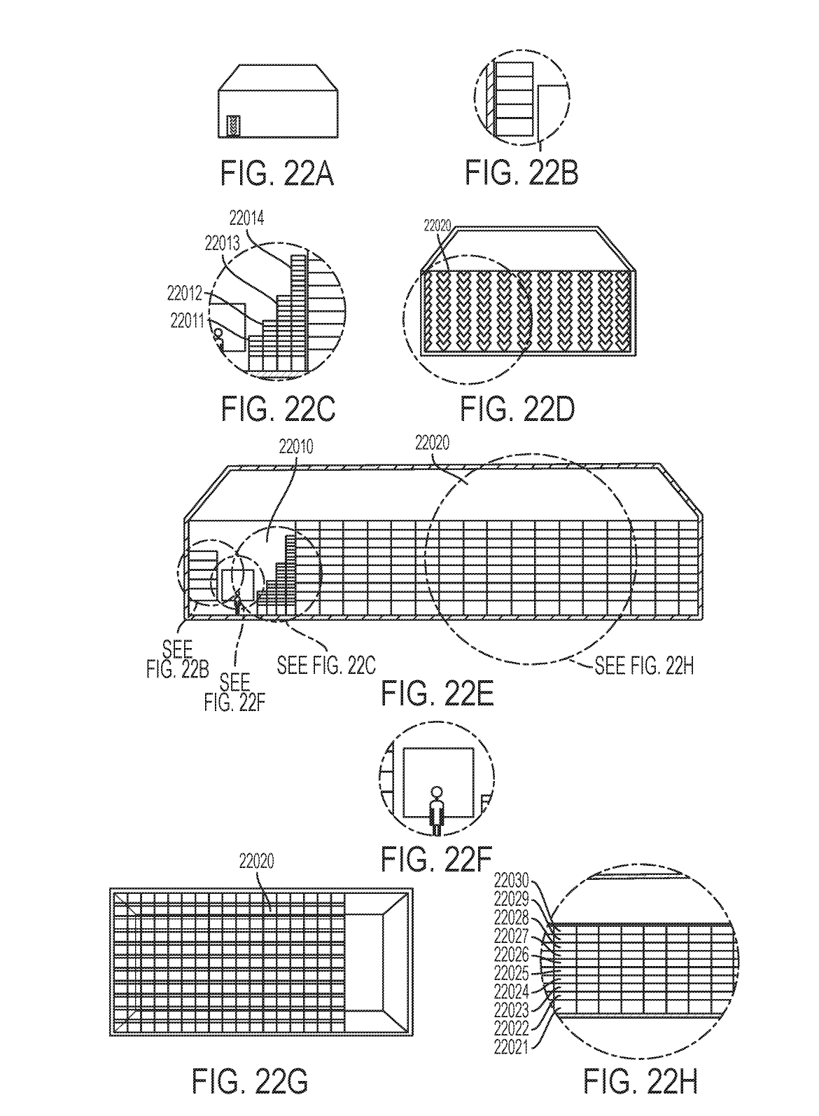

FIGS. 22A-H depict examples of indoor system configurations in which the aerohydroponic system of the invention with stackable, divisible containers can be used. In these examples, trapezoidal 22010 and mirrored trapezoidal 22020 configurations demonstrate the ability to construct implementations of varying height (number of stacked containers). The trapezoidal containers can be stacked in a variety of heights, for example 4 units 22011, 7 units 22012, 12 units 22013, 20 units 22013. In the same way the mirrored trapezoidal containers can be stacked in a variety of heights (although only 10 are depicted), as shown by 22021, 22022, 22023, 22024, 22025, 22026, 22027, 22028, 22029, and 22030.

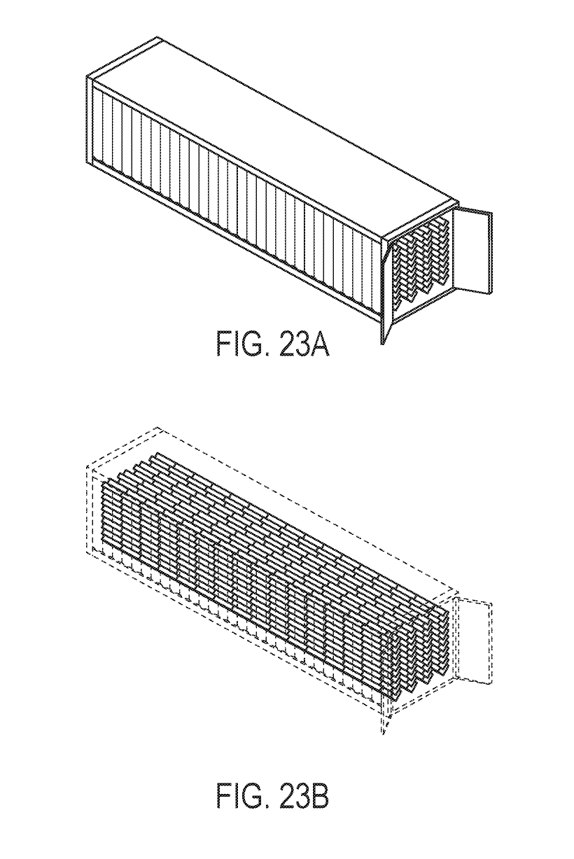

FIGS. 23A-B depict examples of the aerohydroponic system of the invention with stackable, divisible containers can be used system configured for use inside a shipping container.

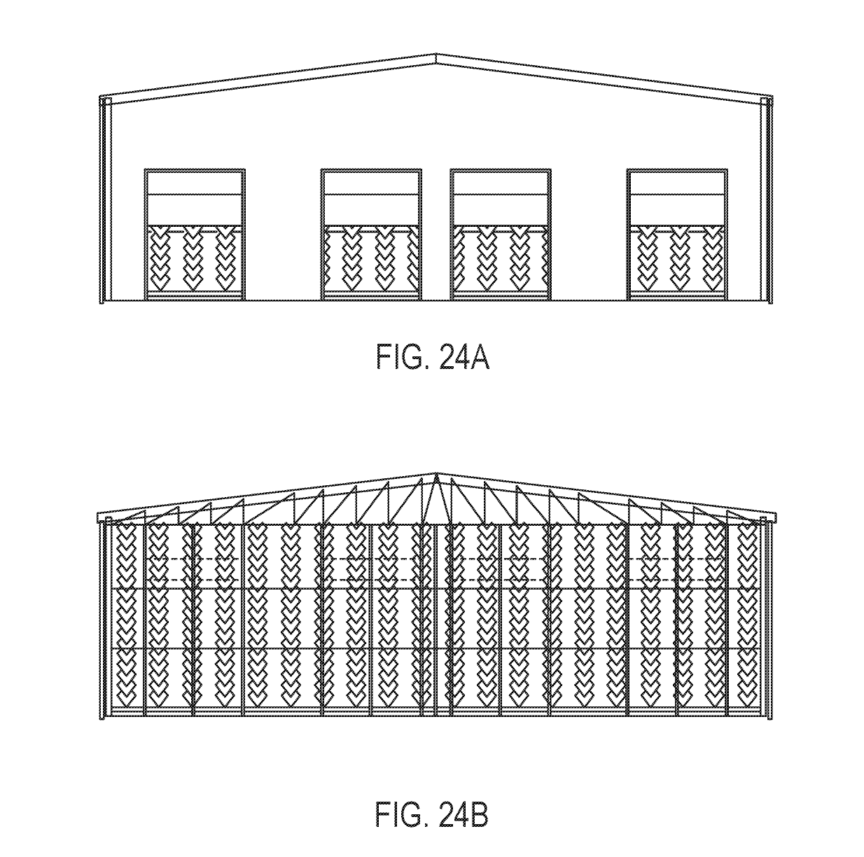

FIGS. 24A-B depict examples of the aerohydroponic system of the invention with stackable, divisible containers configured for use inside a warehouse.

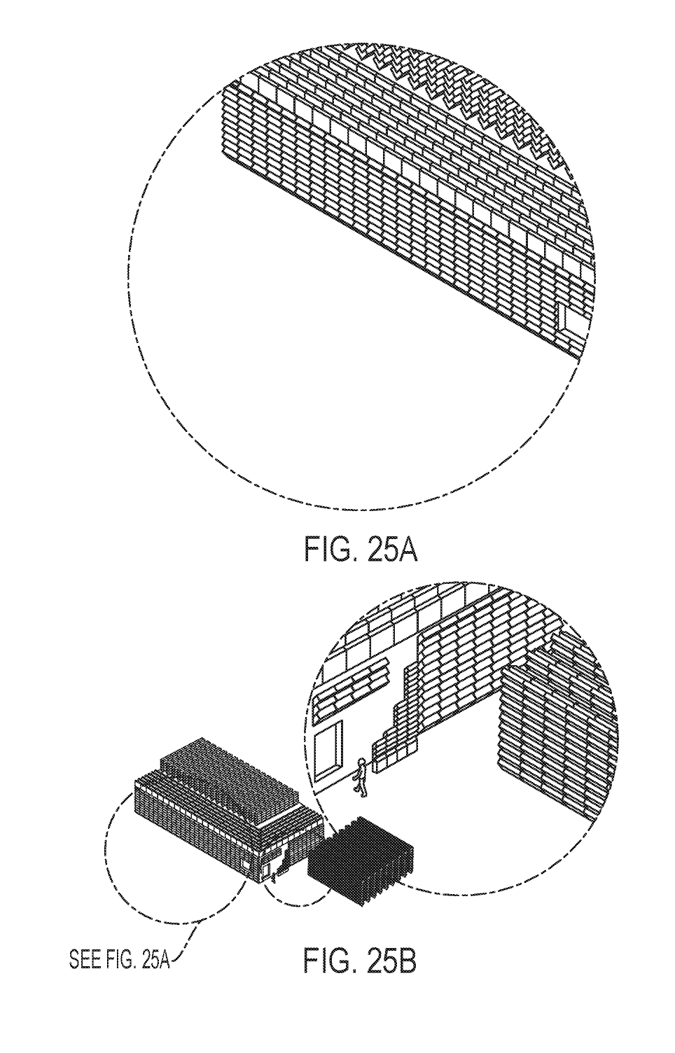

FIGS. 25A-B depict examples of outdoor configurations for the aerohydroponic system of the invention with stackable, divisible containers.

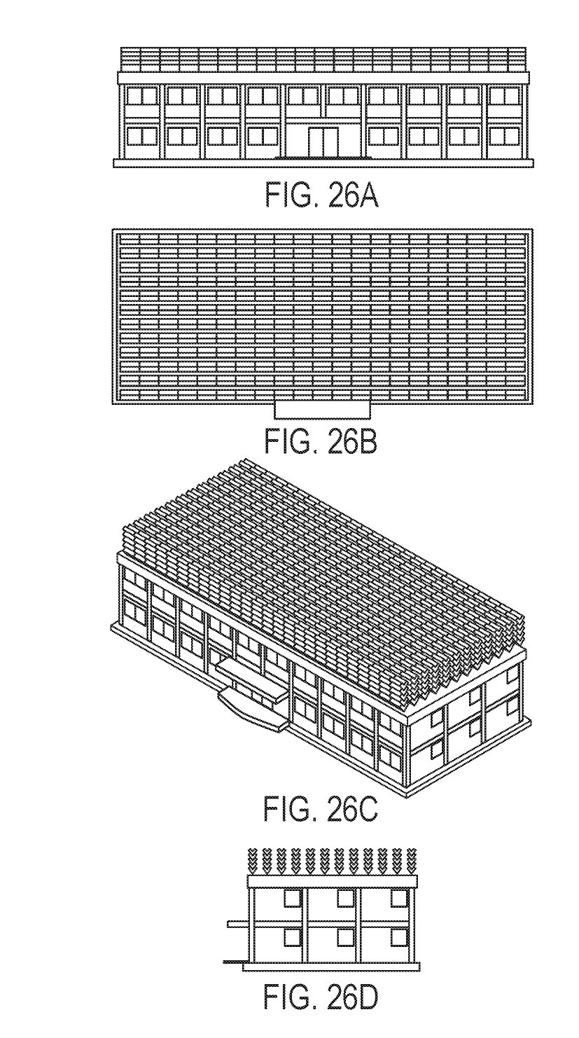

FIGS. 26A-D depict examples of the aerohydroponic system of the invention with stackable, divisible containers system configured for use on a roof.

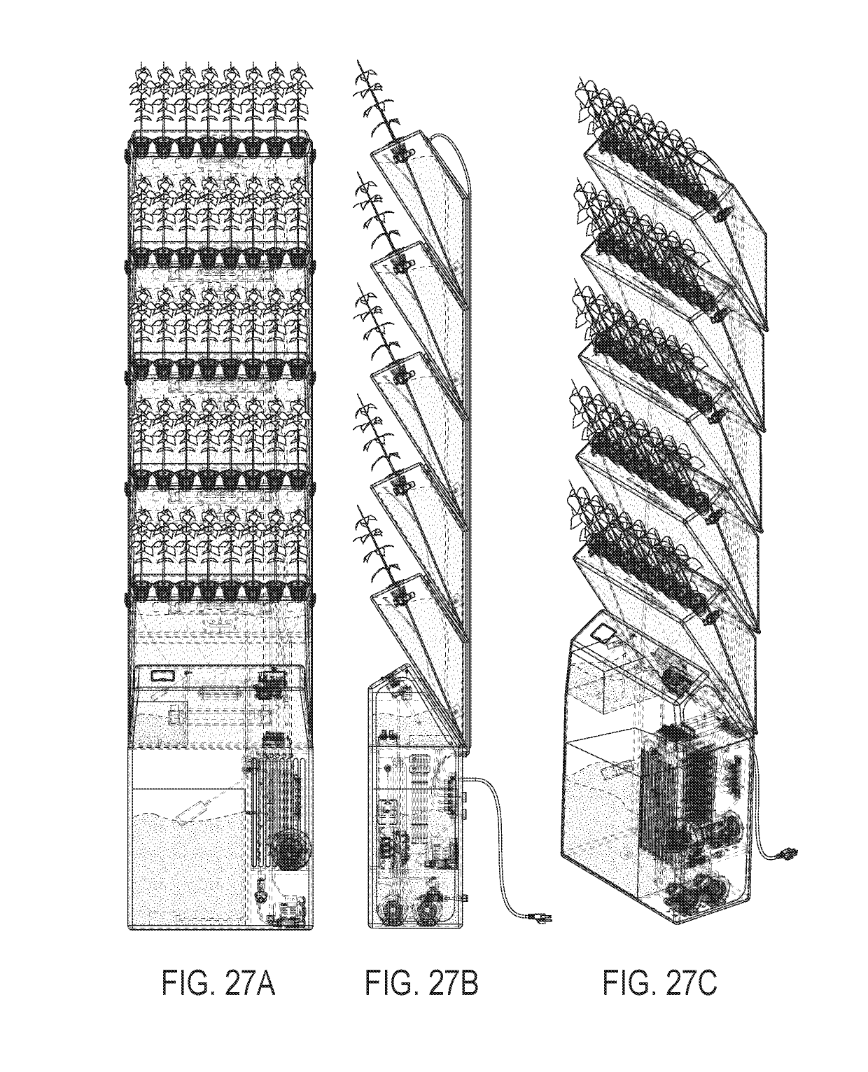

FIGS. 27A-C depict transparent front side and perspective views of a complete aerohydroponic system with vertical, stackable containers according to the invention.

The invention has been described in terms of particular embodiments. The alternatives described herein are examples for illustration only and not to limit the alternatives in any way. Certain steps of the invention can be performed in a different order and still achieve desirable results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. A system for aerohydroponic horticulture comprising:
a plurality of containers, the containers each having a face portion and at least one intake aperture and outtake aperture configured to hold an aqueous nutrient solution and plant with roots partially or wholly submerged in the aqueous nutrient solution for aerohydroponic growth, the containers dimensioned according to the Fibonnacci Sequence and having at least one conduit connected to the containers at the intake aperture, and the outtake aperture, the at least one conduit comprising an opening to deliver air, and/or aqueous nutrient solution to the containers,
the containers having watertight seal and releasably divisible across the face portion into first and second container portions,
the plurality of containers stacked vertically and in fluid communication through the at least one conduit;
an air delivery system connected to the plurality of containers through the at least one conduit; and
an aqueous nutrient delivery system connected to the plurality of containers through the at least one conduit.

2. The system of claim 1, wherein the containers are trapezoidal, mirrored-trapezoidal, conical, circular, or inverted circular in shape.

3. The system of claim 1, wherein the containers further comprise one or more receptacles for plants, the receptacles comprising a soilless growth medium.

4. The system of claim 3, further comprising a rack and pinion mechanism for revolving the one or more receptacles of the containers.

5. The system of claim 1, wherein the containers further comprise baffling for forming an aqueous nutrient solution reservoir in the containers, the baffling having an adjustable mechanism that regulates the level of the aqueous nutrient solution in the containers.

6. The system of claim 1, wherein the adjustable mechanism comprises a plate with orifices that fits against the baffling and regulative orifices such that the plate orifices and the regulative orifices can be aligned to increase flow or misaligned to decrease flow of nutrient solution in the containers and the air delivery system comprises an inlet and outlet, whereby the inlet draws from ambient environmental air and the outlet is connected to the one or more conduits and provides air to the roots partially or wholly submerged in the aqueous nutrient solution.

7. The system of claim 1, further comprising a frame to house the containers that can be mounted to a wall or other vertical support with fasteners at a mounting point, wherein the containers are removable from the frame and have a center of gravity below the mounting point, wherein internal stanchions provide support to a stack of aerohydroponic containers and permit the use of internal plumbing systems for the conduits.

8. The system of claim 1, further comprising a computing system, wherein the containers are further configured to comprise sensors that can be connected or paired to or with the computing system to measure and store data of aqueous nutrient solution oxygen availability, aqueous nutrient solution nutrient levels (electrical conductivity), aqueous nutrient solution pH level, temperature, barometric pressure, light levels, humidity, carbon dioxide levels, aqueous nutrient solution cistern liquid level and concentrated aqueous nutrient solution cistern liquid level, wherein the computing system can communicate the stored data to a computing device and generate alerts and trigger automated system functionality.

9. The system of claim 1, further comprising an aqueous nutrient solution delivery system comprising a pump or solenoid that introduces fresh water to the aqueous nutrient solution cistern and one or more conduits that move aqueous nutrient solution from the aqueous nutrient solution cistern to a first, uppermost container and additional containers, wherein the first container and additional containers are in fluid communication.

10. The system of claim 1, further comprising a photo radiation unit comprising at least one vertically or transversely mounted photoradiation device.

11. The system of claim 1, the aqueous nutrient delivery system further comprises at least one dehumidifier unit that adds water to the aqueous nutrient solution cistern.

12. The system of claim 1, further comprising a track system with movable boom capable of moving in three dimensions along an x, y, and z, axis to which the photoradiation device is mounted, further comprising a data acquisition and pruning and harvesting system mounted to the track system, wherein the data acquisition system comprises a camera for obtaining pictures, wherein the pruning and harvesting system comprise a compressed air mechanism, saw, or shears.

13. A method for aerohydroponic growing comprising:
depositing at least one or more seeds inside soilless growth medium inside one or more receptacles;
placing the one or more receptacles inside an individual container, the container having a face portion and at least one intake aperture and outtake aperture, the container dimensioned according to the Fibonnacci Sequence and having at least one conduit connected to the container at an intake aperture, and an outtake aperture, and one or more sensors connected to a computing system that measures data including: aqueous nutrient solution oxygen availability, aqueous nutrient solution nutrient levels (electrical conductivity), aqueous nutrient solution pH level, temperature, barometric pressure, light levels, humidity, carbon dioxide levels, aqueous nutrient solution cistern liquid level and concentrated aqueous nutrient solution cistern liquid level and store the data on the computing system, wherein the computing system monitors the sensors, and communicates the stored data to a computing device and generate alerts;
stacking a plurality of the individual containers vertically so that the stacked containers are in fluid communication through the intake aperture and the outtake aperture; and
providing an aqueous nutrient solution to the containers and so that plants will grow in the receptacles with roots partially or wholly submerged in the aqueous nutrient solution for aerohydroponic growth;
providing oxygen to the containers through an air delivery system comprising an air pump and gaseous diffusion apparatus in fluid communication with the intake aperture and the outtake aperture.

14. The method of claim 13 further comprising:
connecting or pairing the one or more sensors to a computing system;
measuring and storing in the computer system data of aqueous nutrient solution oxygen availability, aqueous nutrient solution nutrient levels, aqueous nutrient solution pH level (electrical conductivity), temperature, barometric pressure, light levels, humidity, carbon dioxide levels, aqueous nutrient solution cistern liquid level and concentrated aqueous nutrient solution cistern liquid level.

15. The method of claim 13 further comprising the computing system sending data and alerts from the computing system to a user computer when aqueous nutrient solution oxygen availability, aqueous nutrient solution nutrient levels aqueous nutrient solution pH level (electrical conductivity), temperature, barometric pressure, light levels, humidity, carbon dioxide levels, aqueous nutrient solution cistern liquid level and concentrated aqueous nutrient solution cistern liquid level falls outside of predetermined ranges.

16. The method of claim 13 further comprising removing and opening the containers to prune, harvest or transplant plants growing in the containers without disrupting or damaging roots of plants.

17. A container for growing plants aerohydroponically comprising:
a face portion, a rear portion, and side portion, and at least one intake aperture and outtake aperture, for aerohydroponic growth, dimensioned according to the Fibonnacci Sequence configured to hold an aqueous nutrient solution and plant with roots partially or wholly submerged in the aqueous nutrient solution for aerohydroponic growth and to connect to at least one conduit connected to the containers at the intake aperture, and the outtake aperture, the at least one conduit comprising an opening to deliver air, and/or aqueous nutrient solution to the containers, the containers releasably divisible across the face into first and second container portions.

18. The container of claim 17 further comprising one or more sensors that can be connected to a computing system to measure and store data of aqueous nutrient solution oxygen availability, aqueous nutrient solution nutrient levels, aqueous nutrient solution pH level (electrical conductivity), temperature, barometric pressure, light levels, humidity, carbon dioxide levels, aqueous nutrient solution cistern liquid level and concentrated aqueous nutrient solution cistern liquid levels.

19. The container of claim 17, further comprising one or more receptacles for housing plants, the receptacles comprising a soilless growth medium;
and a rack and pinion mechanism for revolving the receptacles.

20. The container of claim 17, further comprising an adjustable mechanism to control the delivery of nutrient solution to the containers.

21. The container of claim 20 wherein the adjustable mechanism comprises a plate with orifices that fits against the baffling and regulative orifices such that the plate orifices and the regulative orifices can be aligned to increase flow or misaligned to decrease flow of nutrient solution in the container.
